(19) United States
(12) Patent Application Publication
(10) Pub. No.: US 2026/0296205 A1
(43) Pub. Date: Oct. 1, 2026

(54) SYSTEM AND METHOD FOR CHARGING AND DISCHARGING BATTERIES USING CONTROL BARRIER FUNCTION ALGORITHMS

(71) Applicant: The Regents of the University of California, Oakland, CA (US)

(72) Inventors: Ricardo de Castro, Merced, CA (US); Shuang Feng, Merced, CA (US); Iman Ebrahimi, Merced, CA (US)

(21) Appl. No.: 19/550,524

(22) Filed: Feb. 26, 2026

Related U.S. Application Data
(60) Provisional application No. 63/778,600, filed on Mar. 27, 2025.

(51) Int. Cl. B60L 3/00; B60L 7/18

(52) U.S. Cl. CPC B60L 3/0046; B60L 7/18; B60L 2240/14; B60L 2240/545; B60L 2240/547

(57) ABSTRACT

A system and method implement a control barrier function (CBF) approach for fast charging and discharging of batteries under temperature, state of charge (SoC), and terminal voltage constraints. To improve numerical efficiency, a cascade CBF formulation divides this safety problem into multiple layers that are easier to formulate and implement. In a charging scenario, experimental results indicate that the present algorithm reduces charging time by 20% in comparison to traditional constant current, constant voltage (CCCV) methods without violating electro-thermal safety constraints. A discharging experiment illustrates that the cascade CBF effectively limits the battery's performance to ensure compliance with safety constraints.

### CROSS-REFERENCE TO RELATED APPLICATIONS

This application claims the benefit of, and priority to, U.S. Provisional Patent Application Ser. No. 63/778,600 filed on Mar. 27, 2025. The entire contents of the foregoing application are incorporated by reference herein.

### BACKGROUND

Lithium-ion (Li-ion) batteries are widely used in various applications due to their high energy density, lightweight design, and rechargeable nature. Many of these applications require both fast charging and fast discharging capabilities. For example, electric vehicles (EVs) benefit from fast charging to minimize waiting times at charging stations and require fast discharging for quick acceleration during driving. Similarly, battery energy storage systems connected to renewable energy sources require fast charging to capture surplus energy during peak production periods and fast discharging to release stored energy when demand is high. However, without proper control, battery temperature may increase significantly during high rate charging or discharging, leading to potential issues such as overheating, accelerated degradation, thermal runaway, and even explosions or fires. High-current operations can also introduce inefficiencies due to energy losses in the internal resistance of the battery. Maintaining a balance between fast charging and discharging while ensuring safety is a critical challenge for battery management systems.

Implementing battery derating strategies is a common approach to prevent battery failure and extend battery life. These strategies limit operational parameters such as current, voltage, power, state of charge (SoC), or temperature during charging and discharging. Derating strategies can be broadly classified into heuristic (e.g., experiment-based), machine-learning, and model-based approaches. Constant-Current-Constant-Voltage (CC-CV) charging is the most common heuristic approach for charging Li-ion batteries. In CC mode, the battery is charged with a constant current until the terminal voltage reaches a pre-defined threshold, after which the charging switches to CV mode, where the threshold voltage is applied until the charge is complete. While CC-CV is easy to implement, it lacks mechanisms to accelerate charging speed or protect the battery from overheating and other safety concerns.

Various fast charging algorithms have been proposed to improve charging speed. Heuristic-based strategies, such as multistage constant current charging (MSCC), constant power charging (CP), boost charging (BC), and pulse charging (PC), are among currently proposed methods. Similarly, heuristic discharging strategies such as constant current discharge with different C-rates and pulse-current discharging have been explored. However, while easy to implement, these heuristic methods lack direct mechanisms to enforce safety constraints or systematically minimize charging time and often require time-consuming calibration tests to design charging profiles.

Machine learning (ML) and data-driven methods, including reinforcement learning and artificial neural networks (ANN), have also been used in charging and discharging algorithms. These approaches use battery input-output data to construct charging protocols without the need for complex physical battery models. However, ML approaches typically require large and diverse datasets for training, which are computationally expensive, particularly on embedded systems with limited resources. Additionally, concerns about interpretability and transferability to different battery chemistries remain challenges for some ML methods.

Model-based methods use a predictive model of the battery to enforce safety constraints and optimize performance during charging and discharging. The accuracy of this approach depends on the development and calibration of the prediction model, which can range from low-dimension equivalent circuits to complex high-fidelity electrochemical models. Numerous model-based strategies have been proposed. One example is the use of a PID-based controller, derived from an electrothermal model, to limit battery temperature during charging. While simple to implement, this approach cannot handle multiple safety constraints effectively.

Optimization strategies offer a more systematic approach to enforce safety constraints. These strategies can be based on feedforward control architectures, which involve solving an open-loop optimization problem to determine a safe current at the start of the charging process. However, feedforward approaches can suffer from a lack of robustness due to model mismatches. Feedback-based optimization methods, such as model predictive control (MPC), address this issue by re-computing the optimal charging solution at each time step. The main downside of MPC is the high computational effort required. To mitigate this, lightweight optimization techniques have been proposed. For example, one method computes optimal charging currents by analytically inverting an electrochemical battery model and uses proportional-integral feedback control to manage model uncertainties. Another method employs a linear quadratic regulator (LQR) controller to track battery SoC and applies an explicit reference governor (ERG) to handle linear and nonlinear constraints related to battery health. The primary challenge in developing an effective ERG is selecting an appropriate Lyapunov function to manage the nonconvex constraints inherent in the battery's electrochemical model.

Thus, there is a need for a battery management system that enables fast charging and discharging of lithium-ion batteries while maintaining safety constraints, such as temperature, SoC, and voltage, to prevent overheating, degradation, and other failures.

### SUMMARY

According to one embodiment of the present disclosure, a method for charging a battery includes receiving an initial charging current and at least one battery parameter at a processor; calculating a first charging current based on the initial charging current using a first control barrier function that enforces SoC and voltage constraints based on the at least one battery parameter; calculating a safe charging current based on the first charging current using a second control barrier function that enforces a temperature constraint; and controlling charging of the battery using the safe charging current to maintain SoC, voltage, and temperature within specified limits.

Implementations of the above embodiment may include one or more of the following features. In one aspect, the method may include calculating a state of power estimation. The state of power estimation may involve receiving a requested battery power input at the processor; calculating the requested battery current based on the requested battery power; and calculating the maximum safe battery power using cascaded control barrier functions. The requested battery power may be associated with regenerative braking or acceleration in an electric vehicle. The at least one battery parameter may include either an electrical safety limit or a thermal safety limit.

The first control barrier function may be solved through quadratic optimization, minimizing deviation from a reference charging current while subject to SoC and voltage constraints. The second control barrier function may similarly be solved through quadratic optimization, minimizing deviation from the first charging current while subject to temperature constraints.

In other aspects, the method may also include adjusting the safe charging current using a third control barrier function enforcing a lithium plating constraint and controlling charging of the battery using the safe charging current to prevent lithium deposition on an anode surface and maintain battery safety. The method may further include adjusting the safe charging current using a fourth control barrier function enforcing an internal pressure constraint; and controlling charging of the battery using the safe charging current to maintain internal pressure within safe operational limits and prevent electrolyte venting. The method may additionally include adjusting the safe charging current using a fifth control barrier function enforcing a lithium concentration constraint; and controlling charging of the battery using the safe charging current to maintain lithium-ion concentration within operational thresholds and prevent electrolyte depletion or saturation effects. The method may also include adjusting the safe charging current using a sixth control barrier function enforcing a battery aging constraint and controlling charging of the battery using the safe charging current to reduce degradation effects and extend battery lifespan.

According to another embodiment of the present disclosure, a battery management system for charging a battery includes a battery, a charger, and a processor configured to: receive an initial charging current and at least one battery parameter; calculate a first charging current based on the initial charging current using a first control barrier function that enforces state of charge (SoC) and voltage constraints based on the at least one battery parameter; calculate a safe charging current based on the first charging current using a second control barrier function that enforces a temperature constraint; and control the charger to charge the battery using the safe charging current to maintain SoC, voltage, and temperature within specified limits.

Implementations of the above embodiment may include one or more of the following features. In one aspect of the above embodiment, the system may include a processor that is further configured to calculate a state of power estimation for the battery. The processor may perform the state of power estimation by: receiving a requested battery power; calculating a requested battery current based on the requested battery power; and calculating a maximum safe battery power using cascaded control barrier functions. The requested battery power may correspond to regenerative braking or acceleration in an electric vehicle. The at least one battery parameter may include either an electrical safety limit or a thermal safety limit.

The processor may be configured to solve the first control barrier function by performing quadratic optimization that minimizes deviation from a reference charging current, subject to SoC and voltage constraints. The processor may also be configured to solve the second control barrier function by performing quadratic optimization that minimizes deviation from the first charging current, subject to temperature constraints.

In other aspects, the processor may be further configured to adjust the safe charging current using a third control barrier function enforcing a lithium plating constraint and control charging of the battery using the safe charging current to prevent lithium deposition on an anode surface and maintain battery safety. The processor may be also configured to: adjust the safe charging current using a fourth control barrier function enforcing an internal pressure constraint and control charging of the battery using the safe charging current to maintain internal pressure within safe operational limits and prevent electrolyte venting. The processor may be additionally configured to: adjust the safe charging current using a fifth control barrier function enforcing a lithium concentration constraint and control charging of the battery using the safe charging current to maintain lithium-ion concentration within operational thresholds and prevent electrolyte depletion or saturation effects. The processor may be further configured to: adjust the safe charging current using a sixth control barrier function enforcing a battery aging constraint and control charging of the battery using the safe charging current to reduce degradation effects and extend battery lifespan.

### BRIEF DESCRIPTION OF DRAWINGS

Various embodiments of the present disclosure are described hereinbelow with reference to the figures wherein:

FIG. 1 is a schematic circuit diagram of a battery including a voltage source (Voc) in series with an internal resistance (R₀) and two RC pairs (R₁, C₁, R₂, C₂) according to an embodiment of the present disclosure;

FIG. 2 is a table summarizing the electro-thermal battery model states and constraints employed in a central control barrier functions (CBF) formulation according to an embodiment of the present disclosure;

FIG. 3 is a block diagram of a charging system implementing a central CBF algorithm;

FIG. 4 is a block diagram of a battery model divided into electrical and thermal subsystems and corresponding safety functions according to an embodiment of the present disclosure;

FIG. 5 is a table summarizing partitioned battery model of FIG. 4 and constraints employed in a cascade CBF formulation according to an embodiment of the present disclosure;

FIG. 6 is a block diagram of the cascade CBF including two quadratic problems (QPs) according to an embodiment of the present disclosure;

FIG. 7 is a table including pseudocode for a battery fast charging algorithm implementing the cascade CBF according to an embodiment of the present disclosure;

FIG. 8 is a table including pseudocode for a battery state of power (SoP) estimation algorithm implementing the CBFs according to an embodiment of the present disclosure;

FIG. 9 is a flow chart of a method for battery fast charging according to an embodiment of the present disclosure;

FIG. 10 is a flow chart of a method for battery state of power according to an embodiment of the present disclosure;

FIG. 11 is a table summarizing of the simplified electro-thermal battery model (3 states) and constraints employed in the cascade CBF algorithm in a simulated battery modeled based on the battery of FIG. 1 according to an embodiment of the present disclosure;

FIG. 12 is a table of CBF parameters used in the simulations;

FIG. 13 shows simulation results as plots of current, voltage, SoC, and temperature over time of a simulated battery controlled using the CC-CV algorithm and the cascade CBF algorithm according to an embodiment of the present disclosure;

FIG. 14 is a table of computational time statistics of central CBF, MPC, and cascade CBF algorithms according to an embodiment of the present disclosure;

FIG. 15 is a plot of solver computation time of central CBF, MPC, and cascade CBF algorithms according to an embodiment of the present disclosure;

FIG. 16 shows simulation results of cascade CBF algorithm during battery discharge with a scale driving cycle as plots of (a) velocity of the driving cycle, (b) battery current, (c) normalized power derating, (d) terminal voltage, (e) surface temperature and (f) SoC over time according to an embodiment of the present disclosure;

FIG. 17 shows simulation results of CBF algorithm derating with focus on time slots where different constraints are active with plots (a, b) terminal voltage, (c, d) temperature, and (e, f) SoC;

FIG. 18 shows electrical response plots illustrating thermal response for a 5-state battery model and a simplified 3 state battery model according to an embodiment of the present disclosure;

FIG. 19 shows current and temperature plots illustrating thermal response for a 5-state battery model and a simplified 3 state battery model according to an embodiment of the present disclosure;

FIG. 20 is a table of parameters of the simplified battery model used in the experimental validation;

FIG. 21 shows a schematic block diagram (a) and a test bench (b) of a test setup for validation of the battery fast charging algorithm according to an embodiment of the present disclosure;

FIG. 22 shows experimental results as plots of current, voltage, SoC, and temperature over time of a simulated battery controlled using the CC-CV algorithm and the cascade CBF algorithm according to an embodiment of the present disclosure;

FIG. 23 shows experimental results as plots of current over time of a simulated battery controlled using the CC-CV algorithm and the cascade CBF algorithm according to an embodiment of the present disclosure;

FIG. 24 shows experimental results of cascade CBF discharge driving cycle test (a) discharge current, (b) normalized derating factor, (c) temperature, (d) terminal voltage, and (e) SoC according to an embodiment of the present disclosure;

FIG. 25 is a table of formulas of an optimization of an MPC algorithm;

FIG. 26 is a flow chart of the cascade control barrier function, extended with additional safety constraints to deal with lithium platting, pressure and lithium concentrations according to an embodiment of the present disclosure;

FIG. 27 is a schematic circuit diagram of an alternative equivalent circuit of battery composed of a series of two sub-circuits: one for the battery's cathode (positive electrode), and another for the battery's anode (negative electrode) according to an embodiment of the present disclosure; and

FIG. 28 is a block diagram of a physics-based equivalent circuit model (ECM), where F stands for Faraday constant and γ is a constant according to an embodiment of the present disclosure.

### DETAILED DESCRIPTION

The present disclosure provides a new lightweight optimization-based control algorithm for charging and discharging of a battery. The algorithm is based on CBFs, which translate battery safety requirements into a set of safe states and then enforce forward invariance of the safe set, guaranteeing that the system state remains inside this set at all times. CBFs may also be combined with existing legacy controllers, adapting the control actions generated by the legacy controller to enforce safety with reduced performance penalization.

The present disclosure provides:
A new CBF-based control algorithm to enforce electro-thermal safety limits during battery operation. The strategy provides a unified framework to promote safety during fast charging and derated discharge, where performance is decreased to preserve battery safety.
A novel cascade CBF formulation, which splits the design problem into multiple layers, making it easier to solve compared to the traditional single-layer CBF approach. Theoretical analysis demonstrates that this cascade CBF approach provides the same safety guarantees as the single-layer CBF, while reducing computational time by up to three times.
The controller was experimentally validated using a single 26650 LiFePO4 cell. The results demonstrate that the CBF controller reduces by 20% the time it takes to charge the battery from 20% to 70% of the SoC compared to CC-CV charging protocols.

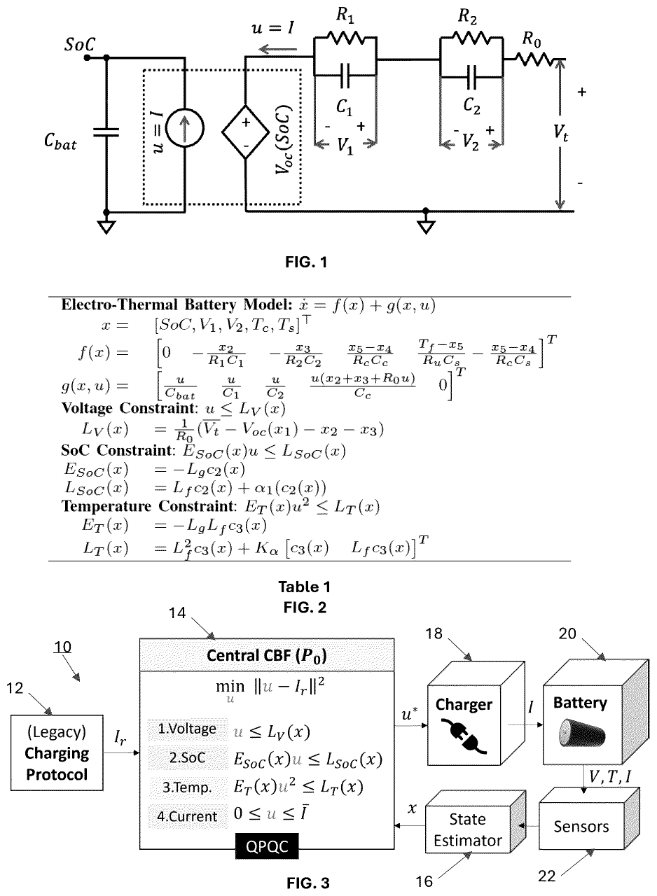

An electro-thermal model of a battery may be used to derive the charging/discharging algorithm. FIG. 1 shows an electrical equivalent circuit that is used to represent the electrical behavior of the battery. This model includes a voltage source in series with an inner resistance R₀, and two RC pairs. The thermal behavior is approximated as a second-order dynamic system, with i) conductive heat transfer between the battery core temperature T_{C} and battery surface temperature T_{S}, and ii) convective heat transfer between T_{S} and the environment temperature T_{f}. The resulting mathematical model is described as follows in formulas (1a-e) below:

$$\frac{dSOC}{dt} ( t ) = \frac{I ( t )}{{C}_{b a t}} \qquad ( 1 a )$$

$$\frac{d {V}_{1}}{dt} ( t ) = - \frac{{V}_{1} ( t )}{{R}_{1} {C}_{1}} + \frac{I ( t )}{{C}_{1}} \qquad ( 1 b )$$

$$\frac{d {V}_{2}}{dt} ( t ) = - \frac{{V}_{2} ( t )}{{R}_{2} {C}_{2}} + \frac{I ( t )}{{C}_{2}} \qquad ( 1 c )$$

$$\frac{d {T}_{c}}{dt} ( t ) = \frac{{T}_{s} ( t ) - {T}_{c} ( t )}{{R}_{c} {C}_{c}} + \frac{I ( t ) ( {V}_{t} ( t ) - {V}_{o c} )}{{C}_{c}} \qquad ( 1 d )$$

$$\frac{d {T}_{s}}{dt} ( t ) = \frac{{T}_{f} - {T}_{s} ( t )}{{R}_{u} {C}_{s}} - \frac{{T}_{s} ( t ) - {T}_{c} ( t )}{{R}_{c} {C}_{s}} \qquad ( 1 e )$$

The values of the resistance-capacity pairs, R₁, R₂, C₁, and C₂, depend on the SoC, current direction, and temperature of the battery (omitted here to simplify the notation). Additionally, Rc, Ru, Cc, and Cs represent the heat conduction resistance, convection resistance, core heat capacity, and surface heat capacity, respectively. The terminal voltage of the battery can be calculated using Kirchhoff's voltage law represented as formula (2):

$${V}_{t} ( t ) = {V}_{o c} ( SoC ) + {V}_{1} ( t ) + {V}_{2} ( t ) + {R}_{0} I ( t ) \qquad ( 2 )$$

The open circuit voltage, Voc, is modeled as a nonlinear function of the SoC. Additionally, the current I is defined to be positive during battery charging and is subject to the constraint of formula (3):

$${I}_{1} \leq I \leq {I}_{2} \qquad ( 3 )$$

Where I₁ is the maximum current allowed by the battery charger, and I₂ is the maximum current that can be drawn from the battery to the load.

The battery model described above can be reformulated into the following nonlinear system represented as formula (4):

$$\dot{x} = f ( x ) + g ( x , u ) \qquad ( 4 )$$

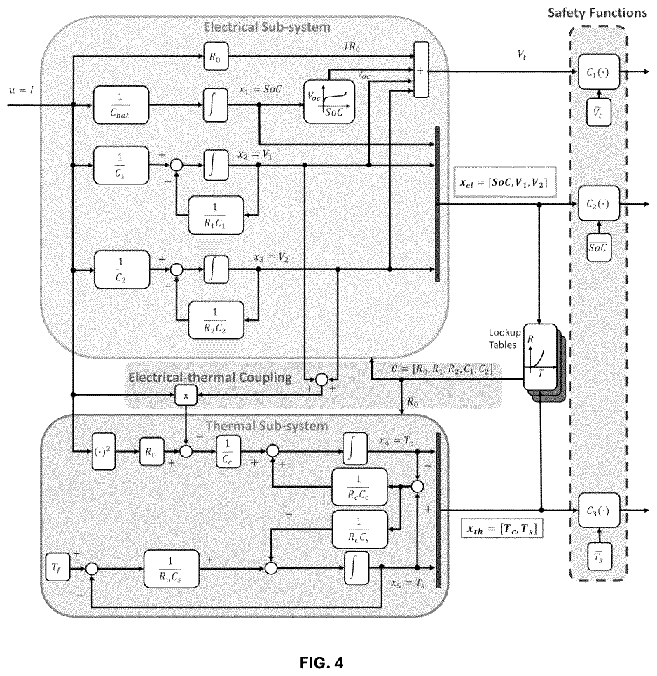

In formula (4), x=[SoC, V1, V2, Tc, Ts] is the state, u=I is the control input. In formula (4), f(·), g(·) encapsulate the electro-thermal model of FIG. 1 and with details provided in Table 1 of FIG. 2, which summarizes an electro-thermal battery model with seven states and constraints used in a central CBF formulation of FIG. 3. The actuation constraints are provided in formula (5):

$$U = \{ u ∈ R : 0 \leq u \leq {I}_{2} \} \qquad ( 5 )$$

The battery can be considered to be in a safe state when the SoC, terminal voltage Vt, and surface temperature Ts remain within pre-defined limits, the battery operates in a safe region. This safe operating region may be encoded using the following safety sets expressed as formulas (6a-c):

$${C}_{1} = \{ x ∈ X : {c}_{1} ( x , u ) = {V}_{tm} - {V}_{t} \geq 0 \} \qquad ( 6 a )$$

$${C}_{2} = \{ x ∈ X : {c}_{2} ( x ) = SoCm - SoC \geq 0 \} \qquad ( 6 b )$$

$${C}_{3} = \{ x ∈ X : {c}_{3} ( x ) = {T}_{s m} - {T}_{s} \geq 0 \} \qquad ( 6 c )$$

When SoC, terminal voltage Vt, and surface temperature Ts remain within predefined limits, the battery is considered to be operating in a safe region. This safe operating region is defined by the following safety sets: SoC represents the maximum allowed SoC, Vt is the maximum terminal voltage permitted during charging, and Ts is the maximum allowed battery temperature. These limits may be specified by the battery manufacturer and/or the user. From a control theory perspective, the battery is considered safe if its trajectory or plot x(t) remains within the set C=C₁∩C₂∩C₃ of formulas (6a-c). Thus, safe charging may be defined as calculating a charging current u∈U that is as close as possible to the requested current Ir, while enforcing forward invariance of the safety set C, which may be expressed by a formula (7):

ifx(0)∈Cthenx(t)∈C,∀t≥0 (7)

A safe charging system for calculating a charging current and implementing a central CBF algorithm is shown in FIG. 3. The central CBF may be defined as a quadratic optimization problem with quadratic constraints (QPQC). The safety constraints depend on the functions LV, E_{SoC}, L_{SoC}, E, LT which are defined in Table 1 of FIG. 2.

With continued reference to FIG. 3, a charging battery system 10 includes a charging protocol module 12 that provides a reference charging current Ir. This may be any suitable or legacy charging protocol that is used as a reference input to the present safety control system. A CBF algorithm is shown as module 14 and may be a central CBF or a cascade CBF as shown in FIG. 6. The CBF minimizes the deviation of the control action u from the reference current Ir, constrained by several battery safety conditions. Specifically:
Voltage Constraint: Ensures the charging current u does not cause the battery voltage to exceed safe limits, defined by the function LV(x)LV (x);
SoC Constraint: Enforces a safe SoC limit;
Temperature Constraint: Maintains the battery temperature within safe operational limits; and
Current Constraint: Limits the current u between 0 and II the maximum allowable current.

The module 14 solves a quadratic program with quadratic constraints (QPQC) to find the optimal control input u* that satisfies the safety constraints. The system 10 also includes a state estimator module 16, which estimates the battery's internal states x based on the sensor data. Accurate state estimation is used for the control barrier function, as it relies on this information to maintain safe operating conditions.

The modules in the charging battery system, such as the charging protocol module 12, the CBF algorithm module 14, and the state estimator module 16, may be embodied in software stored in various types of memory and executed by a processor. These modules can be implemented in a combination of volatile and non-volatile memory components, e.g., in embedded systems, such as those used in automotive applications.

The software for each module may be stored in non-volatile memory, such as flash memory or Electrically Erasable Programmable Read-Only Memory (EEPROM), allowing for persistent storage that retains data even when the system is powered off. This non-volatile memory enables the charging system to maintain essential operational parameters, configuration settings, and safety constraints necessary for effective battery management. Additionally, the system may utilize volatile memory, such as Random Access Memory (RAM), specifically Static RAM (SRAM) or Dynamic RAM (DRAM), for temporary storage of data during runtime. Volatile memory is used to hold real-time data processed by the modules, such as sensor readings and intermediate calculations, which are used for performing computations required by the CBF algorithm and updating the state estimator module with fresh data inputs from sensors monitoring the battery's status.

The processor used to execute the software modules may vary based on the computational demands of the battery management tasks and the embedded system's design requirements. In automotive applications, processors with real-time capabilities and robust error-checking features may be used to ensure high reliability and compliance with automotive safety standards. The processor could be one of several types commonly used in automotive embedded systems:

Microcontrollers (MCUs), such as those from the Infineon AURIX® family or the NXP S32 series, which integrate core processing capabilities with specialized hardware for safety and fault tolerance. These MCUs are designed for tasks such as battery management, powertrain control, and autonomous driving functions;

Digital Signal Processors (DSPs), such as the Texas Instruments TMS570 series, which offer high-speed processing and real-time control capabilities. DSPs are particularly well-suited for handling complex algorithms, such as those needed for real-time state estimation and CBFs; and/or

System-on-Chip solutions, such as those found in NXP's S32G family, which combine the processor with additional essential peripherals (e.g., timers, analog-to-digital converters) on a single chip. SoCs may be used to streamline integration and reduce the system's footprint in space-constrained automotive environments.

The system 10 also includes a charger 18, which receives the optimized charging current u* from the CBF module 14. It regulates the actual charging current I supplied to the battery based on this optimized input. The charger hardware may vary depending on its intended environment, and it could be for example an on-board charger integrated within the vehicle or an external charger located in a garage or at a public charging station.

An on-board vehicle charger with regenerative braking is built into the vehicle and is designed not only to charge the battery from an external power source, such as a home wall outlet or public charging station, but also to harness regenerative braking energy during vehicle operation. Regenerative braking captures kinetic energy that would otherwise be lost as heat during braking and converts it into electrical energy to recharge the battery. The on-board charger, therefore, includes additional power electronics and control circuits that allow it to seamlessly switch between external charging and regenerative charging modes. These chargers may include rectifiers, converters, and bidirectional inverters to accommodate both AC and DC sources, manage the flow of energy back to the battery, and optimize energy recovery. While on-board chargers have size and cooling constraints, they offer the advantage of continuous battery replenishment through regenerative braking, enhancing overall energy efficiency.

An external charger may be stationary or portable may be installed in home garages, commercial parking spaces, or public charging facilities. External chargers may provide faster charging rates compared to on-board chargers due to fewer constraints on size and cooling. These chargers may include robust power conditioning units, enhanced cooling systems, and higher-rated electrical components to safely handle increased power throughput.

Both on-board and external chargers can interface with the CBF module 14 through digital communication protocols, such as CAN bus or Ethernet, to receive the optimized charging current u* and adjust the actual current I supplied to the battery accordingly. The charger hardware typically includes microcontrollers or DSPs to manage charging profiles, safety protocols, and communication with the battery management system. Additionally, the charger may feature power electronics components, such as insulated-gate bipolar transistors (IGBTs), MOSFETs, and high-efficiency transformers, to precisely control current and voltage according to the optimized values provided by the CBF algorithm.

By incorporating either an on-board charger with regenerative braking or an external charger, the system 10 provides flexible charging options, allowing the battery to be charged safely and efficiently in various scenarios—whether at home, on the road, or at high-powered public charging stations. This flexibility enables the battery management system to maintain optimal charging performance and comply with safety constraints in both private and public charging environments.

The battery 20 of system 10 may be any suitable type of battery selected to optimize performance, safety, and cost based on application needs. Lithium-ion (Li-ion) batteries are the most common in EVs and energy storage systems due to their high energy density and cycle life. Suitable Li-ion batteries may be lithium nickel manganese cobalt oxide (NMC), lithium iron phosphate (LFP) batteries, lithium nickel cobalt aluminum oxide (NCA), lithium manganese oxide (LMO), and lithium cobalt oxide (LCO). In embodiments, batteries may be nickel-metal hydride (NiNM) and lead-acid batteries, solid-state batteries, sodium-ion batteries, and other types.

Battery cells can be configured to achieve specific voltage and capacity requirements, with cylindrical, prismatic, and pouch cells used to maximize space and performance. Cylindrical cells, for example, are durable and easily dissipate heat, making them suitable for both portable electronics and EVs. Cells may be arranged in series or parallel, or a combination, to meet voltage and capacity demands, such as the “8S4P” configuration, balancing performance and energy requirements for EVs.

The system 10 also includes a plurality of sensors 22 that collect real-time data on parameters such as voltage (V), temperature (T), and current (I) from the battery 18. These sensors may include voltage sensors to monitor the terminal voltage, thermistors or other temperature sensors placed at specific locations to capture core and surface temperatures, and current sensors (e.g., Hall effect sensors) to measure the charging and discharging current. This real-time information is used by the system 10 to assess the battery's state accurately, enabling the controller to apply the constraints to maintain safe and efficient operation as described below.

The central CBF may be replaced with a cascaded CBF formulation that splits the battery safety formulation into two sub-formulations that are easier to solve. To facilitate this division, the battery model is split into electrical and thermal sub-models as shown in FIG. 4

As noted above, safety limits for operating the battery can be divided into electrical (C₁, C₂) and thermal (C₃) constraints. To enforce these constraints, the battery model may be partitioned into two interconnected subsystems. With reference to FIG. 4, the first portion focuses on the electrical domain, with state xel=[SoC, V1 V2]T, while the second deals with the thermal domain xth=[Tc, Ts]. One coupling mechanism is due to the heat generated in the battery core (Tc), which depends on the heat loss in the RC pairs ((x₂+x₃)u) and Joule losses in the equivalent series resistance (R₀u²). Coupling with states x₂ and x₃ is relatively weak, since the Joule losses dominate the heat generation, as a result R₀u²>>u(x₁+x₂). In view of this, the model can be rewritten as a combination of two quasi-decoupled subsystems shown in formulas (8) and (9):

$$\dot{{x}_{el}} = {f}_{1} ( {x}_{el} , θ ) + {g}_{1} ( {x}_{e l} , θ ) u \qquad ( 8 )$$

$$\dot{{x}_{th}} \approx {f}_{2} ( {x}_{th} ) + {g}_{2} ( {x}_{th} ) {u}^{2} \qquad ( 9 )$$

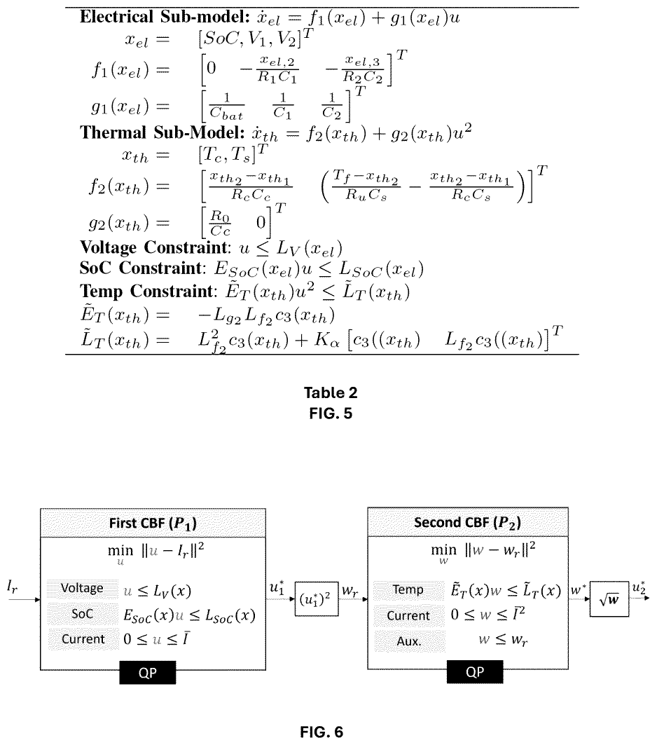

In formulas (8) and (9), f₁, f₂, g₁, g₂ are functions defined in Table 2 of FIG. 5 and θ=[R1, R2, C1, C2]T are the parameters of the electric circuit model. These parameters vary with the SoC and temperature, i.e., θ(xel, xth), introducing another coupling path between the thermal and electrical domains. As described below, θ varies slowly over time and can be treated as a quasi-constant value by the CBF. Specifically, this means that each time the control action is computed, the CBF-based safety input set is updated using the most recent estimate of θ. The inherent robustness properties of the CBF are relied upon to manage any parameter mismatches due to this assumption.

With reference to FIG. 6, the cascade CBF formulation consists of two CBFs. The first CBF enforces the SoC/voltage constraints (C₁, C₂), while the second CBF handles temperature constraints (C₃). The first CBF is formulated as formula (10):

$$P 1 : u 1 * ( x , Ir ) = arg min u ∈ U 1 ( x ) {‖ u - Ir ‖}^{2} \qquad ( 10 )$$

In formula (10), U₁(x) is the set of control inputs capable of enforcing the electrical constraints (SoC and voltage), which can be further defined as formula (11):

$${U}_{1} ( x ) = \{ u ∈ R : u \leq {L}_{V} ( x ) , {E}_{S o C} ( x ) u \leq {L}_{S o C} ( x ) , 0 \leq u \leq I \} \qquad ( 11 )$$

The second CBF that handles temperature constraints may be formulated as formula (12):

$$P 2 : u 2 * ( x , u 1 \text{*)} = arg min u ∈ U 2 ( x ) {‖ u - u 1 * ‖}^{2} \qquad ( 12 )$$

In formula (21) u₁* is the optimal value computed in the first CBF (hence forming a cascade of CBFs) and U₂(x) is the set of control inputs that enforce the temperature constraint defined as formula (13):

$${U}_{2} ( x ) = \{ u ∈ R : \text{?} ( {x}_{th} ) {u}^{2} \leq \text{?} ( {x}_{th} ) , 0 \leq u \leq I \} \qquad ( 13 )$$

In formula (13), [symbol] (xₜₕ) and [symbol] (xₜₕ) correspond to auxiliary functions related to temperature constraint as shown in Table 2 of FIG. 5.

FIG. 6 summarizes the two CBFs that form the cascade CBF wherein the first formulation or problem P₁, is a quadratic program (QP), with quadratic cost and linear inequality (for a fixed state x); which can be solved efficiently using numerous real-time solvers. The second formulation or problem P₂ yields a nonlinear optimization problem due to the presence of the quadratic inequality constraint.

The cascade CBF presented in the previous section solves two optimization problems: P₁ and P₂. Since these problems involve only one decision variable (u), a custom-made numerical solver can be developed to efficiently compute the optimal solution. To better understand the development of this efficient solver, let us consider problem P₁ re-written as formulas (14a-d):

$${‖ u - {I}_{r} ‖}^{2} \qquad ( 14 a )$$

$$u \leq {L}_{V} ( x ) \qquad ( 14 b )$$

$${E}_{S o C} ( x ) u \leq {L}_{S o C} ( x ) \qquad ( 14 c )$$

$$u \geq 0 , u \leq \overline{I} \qquad ( 14 d )$$

Formulas (14a-d) may be merged into two constraints expressed as formulas (15a-c):

$${μ}_{1}^{*} = {arg min}_{u} {‖ u - {I}_{r} ‖}^{2} \qquad ( 15 b )$$

$$u \geq {D}_{1} ( x ) = 0 \qquad ( 15 c )$$

$$u \leq {D}_{2} ( x ) = min ( \overline{I} , {L}_{V} ( x ) , \frac{{L}_{S o C} ( x )}{{E}_{S o C} ( x )} )$$

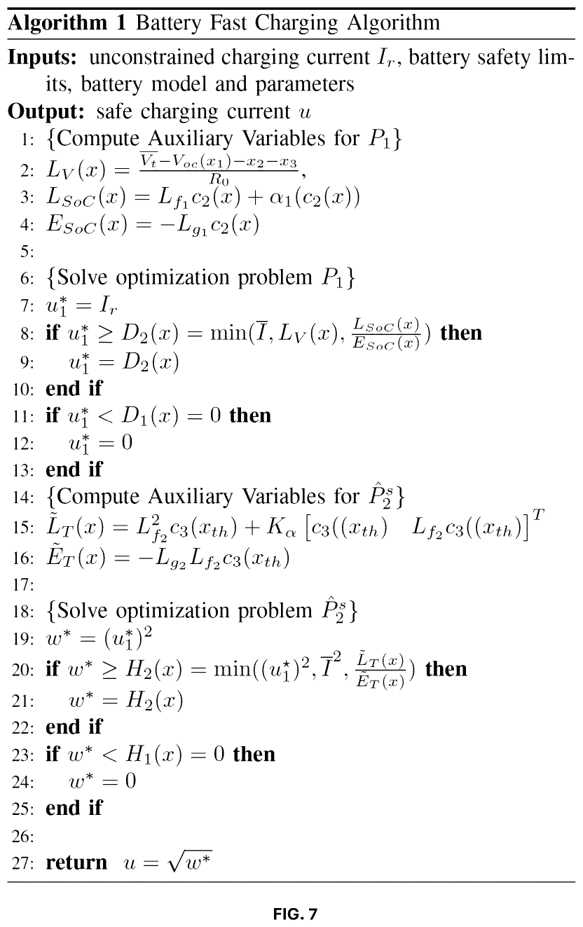

The formulas (15a-c) represent a scalar optimization problem with upper (D₂) and lower (D₁) bounds. A numerical solution may be calculated by: i) computing an unconstrained optimal solution where u=Ir and then ii) clipping the solution to fulfill the bounds (D₁, D₂) (See lines 8-13 of pseudocode of Algorithm 1 of FIG. 7.

The second optimization problem, P₂, can be solved in a similar fashion. More specifically, the two upper-bound inequalities on w in P₂ can be merged into one, leading to formulas (16a-c):

$${min}_{w} {‖ w - {( {u}_{1}^{*} )}^{2} ‖}^{2} \qquad ( 16 a )$$

$$w \geq {H}_{1} ( x ) = 0 \qquad ( 16 b )$$

$$w \leq {H}_{2} ( x ) = min ( {( {u}_{1}^{*} )}^{2} , {\overline{I}}^{2} , \frac{{\hat{L}}_{T} ( x )}{{\hat{E}}_{T} ( x )} ) \qquad ( 16 c )$$

The overall fast charging algorithm is presented in Algorithm 1. The numerical operations of this algorithm are of low complexity. For instance, the auxiliary variables L_{V}, E_{SoC}, L_{SoC}, [symbol] D₁, D₂, H₁, H₂ can be evaluated using simple operations such as multiplication, division, minimum, and maximum. Only a few if-then structures are utilized. In contrast to other numerical solvers, such as active-set or interior-point methods, this algorithm does not rely on iterative schemes and can be computed in deterministic time. This fast-charging algorithm is well-suited for implementation in low-cost embedded microcontrollers, commonly used in automotive applications.

Promoting battery safety during driving (or discharging) of EVs is slightly different from the fast-charging problem as described above. First, in addition to enforcing upper limits on voltage, SoC, and temperature, the battery controller also ensures that the lower limits for voltage and SoC are not violated. These constraints may be expressed as formulas (17a-b):

$${C}_{d 1} = \{ x ∈ X : {c}_{d 1} ( x , u ) = {V}_{t} - {V}_{t}^{min} \geq 0 \} \qquad ( 17 a )$$

$${C}_{d 2} = \{ x ∈ X : {c}_{d 2} ( x ) = S o C - S o {C}_{min} \geq 0 \} \qquad ( 17 b )$$

In formulas (17a-b), SoCₘᵢₙ is the minimum allowed SoC and Vt is the minimum terminal voltage. Additionally, during driving, the battery current may not be directly controlled. Instead, the battery management system informs the vehicle's powertrain about its SoP, representing the maximum power that can be safely extracted from the battery pack without violating safety constraints. This information is then used by the vehicle control unit to limit motor torque, ensuring that the maximum battery power is not exceeded. This disclosure also provides an SoP estimator for the battery that utilizes CBFs and the electrical-equivalent circuit model of the battery. This approach takes a requested battery power from the vehicle control unit, denoted as

$${p}_{b a t}^{*} ,$$

and returns a power recommendation, P_{bat}, that the battery can safely deliver. In other words, the SoP estimator is configured to calculate safe power P_{bat} that is as close as possible to

$${p}_{b a t}^{*} ,$$

while enforcing the current constraint and the forward invariance of C_{d}=C₁∩C₂∩C₃∩C_{d1}∩C_{d2}.

The output of the SoP estimator may also be characterized as a battery derating problem because it may result in a loss of vehicle performance

$$( i . e . , \vert {p}_{bat} \vert < \vert {p}_{b a t}^{*} \vert )$$

and given that the battery model of FIG. 4 uses current I as the control input, it is practical to analyze the SoP estimation problem with I as the manipulated variable. Consequently, the battery current u=I as a “virtual” input that the controller adjusts during driving conditions. The battery power can be converted to a battery current setpoint through the following change of variable as shown in formula (18):

$${p}_{b a t}^{*} = {V}_{t} ( {I}^{*} ) {I}^{*} \qquad ( 18 )$$

In formula (18) I* is the expected battery current required to deliver the requested power, and Vt is the terminal voltage as defined by Formula (2). The RC dynamics may be disregarded to simplify the SoP calculation. The solution to the SoP estimation problem may be divided into two parts: i) regenerative braking

$$( {p}_{b a t}^{*} > 0 ,$$

and ii) acceleration

$$( {p}_{b a t}^{*} < 0 ) .$$

During regenerative braking, the EV powertrain functions as a charger. This allows for the use of the fast-charging algorithms presented above for SoP estimation. For instance, the central CBF of FIG. 3 approach can be adapted to estimate the maximum regenerative current (I⁺) as expressed by formula (19):

$$P 0 + : I += arg min u ∈ U 0 ( x ) {‖ u - I * ‖}^{2} \qquad ( 19 )$$

This limit can then be mapped into a safe regenerative power as expressed by formula (20):

$${p}_{b a t} = {V}_{t} ( {I}^{+} ) {I}^{+} \qquad ( 20 )$$

Considering the SoP estimation during battery discharge

$$( {p}_{b a t}^{*} < 0 ) ,$$

the constraints C₁ and C₂ may be disregarded since the SoC and voltage are decreasing. Thus, moving away from the upper limits, SoC, Vₜ. Instead, lower limits encoded via C_{d1} and C_{d2} are considered, resulting in formulas (21):

$${U}_{0}^{-} ( x ) = \{ u ∈ R : - u \geq - {L}_{d}^{V} ( x ) , {L}_{d}^{S o C} ( x ) - {E}_{d}^{S o C} ( x ) u \geq 0 , {E}_{T} ( x ) {u}^{2} \leq \text{?} ( x ) , I \leq u \leq 0 \} \qquad ( 21 )$$

$$where :$$

$${L}_{d}^{V} ( x ) = {V}_{o c} ( {x}_{1} ) - {x}_{2} - {x}_{3} - {V}_{t} ,$$

$${L}_{d}^{S o C} ( x ) = {L}_{f 1} {c}_{d 2} ( x ) + {α}_{1} ( {c}_{d 2} ( {x}_{el} ) ) ,$$

$${E}_{d}^{S o C} ( x ) = - {L}_{g 1} {c}_{d 2} ( {x}_{e l} ) .$$

This safe set of currents can be incorporated into the central CBF design of FIG. 3 to evaluate the maximum (safe) discharge current (I⁻) as formula (22):

$$P\_ 0 \hat{} - : I \hat{} -= arg \{ min ⊤ \{ u ∈ U\_ 0 \hat{} - ⊢ ( x ⊣ ) \} \{ \vert \} \} u - I \hat{} * \vert \hat{} 2 \qquad ( 22 )$$

Finally, the maximum safe discharge current can be mapped into power via P_{bat}=Vₜ(I⁻)I⁻. Note that the SoP estimation problems

$${P}_{0}^{+} and {P}_{0}^{-}$$

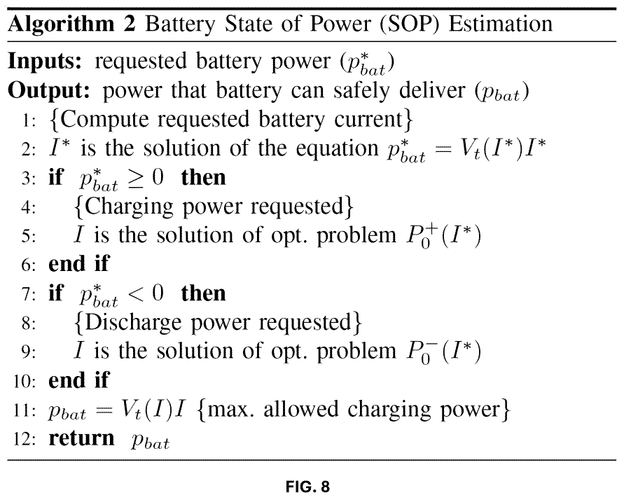

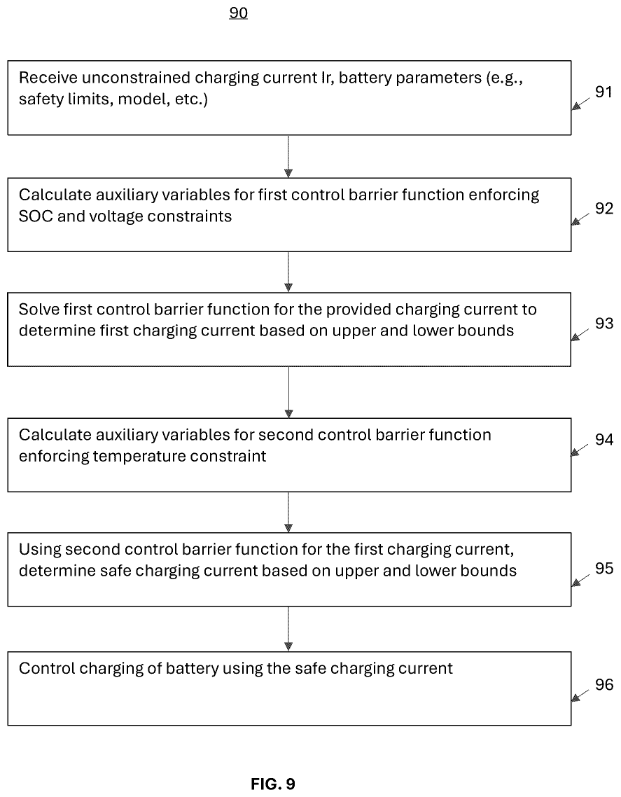

can be re-formulated as cascade CBFs, though these extensions are omitted here for brevity. Pseudocode of Algorithm 2 of FIG. 8 summarizes the main steps in SoP power estimation. To quantify the amount of vehicle performance loss, we propose the following normalized derating factor expressed as formula (23):

$$ρ = \{ \begin{matrix}1 & if {p}_{bat}^{*} = {p}_{bat} \\ \frac{{p}_{bat}}{{p}_{bat}^{*}} & otherwise\end{matrix} \qquad ( 23 )$$

From a practical perspective, ρ quantifies the fraction of power that the battery can deliver to the vehicle without violating safety constraints. In some cases, the parameters of the electrical-equivalent battery model vary depending on the sign of the battery current. If this occurs, different battery parameters can be used to compute the maximum discharge current/power for charging and discharging conditions.

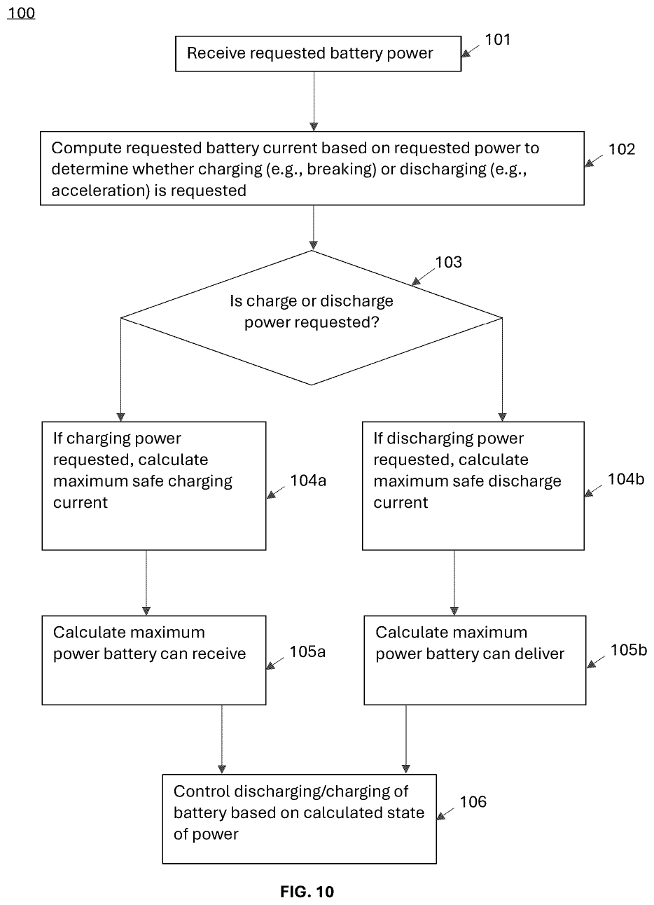

The methods of FIGS. 9 and 10 are based on the disclosed cascade CBF algorithms, which may be embodied in software (e.g., pseudocode of FIGS. 7 and 8, respectively) stored in memory and executable by a processor, such as those disclosed above.

The method 90 depicted in FIG. 9 is used for fast charging the battery 20 using cascade CBF algorithm and begins at step 91, where an unconstrained charging current, Ir, is received along with relevant battery parameters, such as safety limits, the battery model, and other applicable information. The parameters and the current value are provided to a processor from memory storing the parameters and the charging current. This initial input establishes a foundation for the charging protocol by providing the maximum possible charging current before constraints are applied. Moving to step 92, the process calculates auxiliary variables for the first CBF, which enforce constraints related to the battery's SoC and voltage. These auxiliary variables assist in maintaining the SoC and voltage within recommended operational ranges during charging.

In step 93, the first CBF is solved for the provided charging current, and based on this function, the method determines an initial charging current that respects specified upper and lower bounds. These bounds help ensure that the SoC and voltage do not exceed or fall below their intended ranges. Proceeding to step 94, the process calculates auxiliary variables for the second CBF, which address temperature constraints. These variables allow the method to consider thermal limits, providing an additional layer of safety to the charging process.

In step 95, the second CBF is applied to the initial charging current derived from the first CBF, further adjusting it according to temperature-related upper and lower bounds. This step results in a final safe charging current that aligns with all defined constraints for SoC, voltage, and temperature. Finally, in step 96, the method uses this calculated safe charging current to manage the charging of the battery, helping to keep the charging process within preferred limits for all monitored parameters and supporting both performance and safety of the battery system.

The method 100 illustrated in FIG. 10 is used to determine the state of power of the battery 20. The method 100 begins with step 101, where the system receives a requested battery power, which can be for either charging or discharging purposes, depending on the requirements at that moment. In step 102, based on this requested power, the system computes the necessary battery current and determines whether this request is for charging (e.g., for braking energy capture) or for discharging (e.g., acceleration support). This determination helps the system 10 decide which path to follow for managing the battery's power flow.

Step 103 evaluates whether the power request is for charging or discharging. If charging power is requested, the process follows the path to step 104a, where the maximum current for charging is calculated using cascade CBFs to ensure that the calculated charging current remains within safe bounds for SoC, voltage, and temperature. After calculating this safe charging current, step 105a computes the maximum power that the battery can safely receive, taking into account the constraints imposed by the battery's capacity and thermal limits.

Alternatively, if discharging power is requested, the process moves to step 104b, where the maximum safe discharge current is determined using cascade CBFs, which ensures that the discharge current respects the battery's SoC, voltage, and temperature constraints, allowing the battery to safely provide the required power. Following this, step 105b calculates the maximum power that the battery can deliver based on its current state and thermal profile.

Finally, in step 106, the system controls the battery's charging or discharging operations based on the calculated state of power. This control step ensures that the battery operates within safe limits, effectively managing the power flow to meet the requested charging or discharging needs while maintaining adherence to safety constraints across all operating parameters.

The methods 90 and 100 utilize two cascade CBFs to enforce the SoC, voltage and temperature within certain safety limits. These methods may also be used to enforce additional safety constraints, such as lithium plating, solid electrolyte interphase (SEI) reaction rate, solid phase surface concentration, electrolyte concentration, internal pressure of the battery.

The disclosed cascade CBF framework currently employs two primary CBFs: one enforcing state of charge (SoC) and voltage constraints and another managing temperature constraints. While these functions ensure fundamental electro-thermal safety limits during battery operation, additional safety mechanisms can be incorporated into the cascade structure to address other critical failure modes and degradation mechanisms. Specifically, further CBFs can be layered onto the existing framework to monitor and control lithium plating, internal pressure buildup, lithium concentration, and long-term battery degradation.

One such addition is a lithium plating constraint (CBF3), which prevents lithium-ion deposition on the anode surface that can occur due to high charging rates or low operating temperatures. By integrating a physics-based equivalent circuit model (ECM) of the anode and imposing constraints on the anode voltage, the system can dynamically adjust charging currents to prevent conditions that promote lithium plating. This constraint is particularly beneficial for high-energy-density lithium-ion batteries, as it reduces the risk of capacity fade and short-circuit failures due to dendrite formation.

A further enhancement involves a battery pressure constraint (CBF4), which ensures that the internal pressure of the battery remains within safe limits. Internal pressure is influenced by electrolyte decomposition, gas evolution from solid electrolyte interphase (SEI) breakdown, and temperature fluctuations. This additional CBF uses a combination of electrochemical models and temperature-dependent gas generation equations to predict pressure buildup and modulate charging or discharging currents accordingly. Enforcing this constraint helps mitigate risks associated with electrolyte venting, thermal runaway, and mechanical deformation of the battery casing.

Another parameter to control is lithium concentration in the electrolyte (CBF5). Lithium-ion transport between electrodes is fundamental to battery operation, and imbalances in lithium concentration can lead to over-depletion or saturation effects, affecting battery performance and efficiency. This CBF can be formulated based on a physics-informed ECM that includes mass transport equations for lithium-ion diffusion. By enforcing constraints on electrolyte and electrode lithium concentrations, this function prevents excessive charge accumulation or depletion, enhancing battery longevity and power delivery stability.

Lastly, the battery aging constraint (CBF6) can be implemented using semi-empirical degradation models that account for capacity fade and impedance growth over repeated charge-discharge cycles. By incorporating empirical aging equations into the cascade CBF framework, the system can regulate current levels to balance performance with long-term durability. This constraint ensures that the battery operates within parameters that minimize irreversible chemical side reactions, ultimately extending its usable lifespan.

The integration of these additional CBFs into the cascade framework provides a multi-layered safety mechanism, ensuring that not only immediate operational constraints like SoC, voltage, and temperature are satisfied, but also long-term degradation, chemical stability, and mechanical integrity constraints are actively managed. This modular structure enables adaptive battery management strategies that dynamically adjust to operating conditions, offering a significant advancement over conventional charge regulation techniques.

The disclosed cascade CBF framework currently employs two primary CBFs: one enforcing state of charge (SoC) and voltage constraints and another managing temperature constraints. While these functions ensure fundamental electro-thermal safety limits during battery operation, additional safety mechanisms can be incorporated into the cascade structure to address other critical failure modes and degradation mechanisms. Specifically, further CBFs can be layered onto the existing framework to monitor and control lithium plating, internal pressure buildup, lithium concentration, and long-term battery degradation.

One such addition is a Lithium Plating Constraint (CBF3), which prevents lithium-ion deposition on the anode surface that can occur due to high charging rates or low operating temperatures. By integrating a physics-based equivalent circuit model (ECM) of the anode and imposing constraints on the anode voltage, the system can dynamically adjust charging currents to prevent conditions that promote lithium plating. This constraint is particularly beneficial for high-energy-density lithium-ion batteries, as it reduces the risk of capacity fade and short-circuit failures due to dendrite formation.

A further enhancement involves a Battery Pressure Constraint (CBF4), which ensures that the internal pressure of the battery remains within safe limits. Internal pressure is influenced by electrolyte decomposition, gas evolution from solid electrolyte interphase (SEI) breakdown, and temperature fluctuations. This additional CBF uses a combination of electrochemical models and temperature-dependent gas generation equations to predict pressure buildup and modulate charging or discharging currents accordingly. Enforcing this constraint helps mitigate risks associated with electrolyte venting, thermal runaway, and mechanical deformation of the battery casing.

Another parameter to control is Lithium Concentration in the Electrolyte (CBF5). Lithium-ion transport between electrodes is fundamental to battery operation, and imbalances in lithium concentration can lead to over-depletion or saturation effects, affecting battery performance and efficiency. This CBF can be formulated based on a physics-informed ECM that includes mass transport equations for lithium-ion diffusion. By enforcing constraints on electrolyte and electrode lithium concentrations, this function prevents excessive charge accumulation or depletion, enhancing battery longevity and power delivery stability.

Lastly, the Battery Aging Constraint (CBF6) can be implemented using semi-empirical degradation models that account for capacity fade and impedance growth over repeated charge-discharge cycles. By incorporating empirical aging equations into the cascade CBF framework, the system can regulate current levels to balance performance with long-term durability. This constraint ensures that the battery operates within parameters that minimize irreversible chemical side reactions, ultimately extending its usable lifespan.

The integration of these additional CBFs into the cascade framework provides a multi-layered safety mechanism, ensuring that not only immediate operational constraints like SoC, voltage, and temperature are satisfied, but also long-term degradation, chemical stability, and mechanical integrity constraints are actively managed. This modular structure enables adaptive battery management strategies that dynamically adjust to operating conditions, offering a significant advancement over conventional charge regulation techniques.

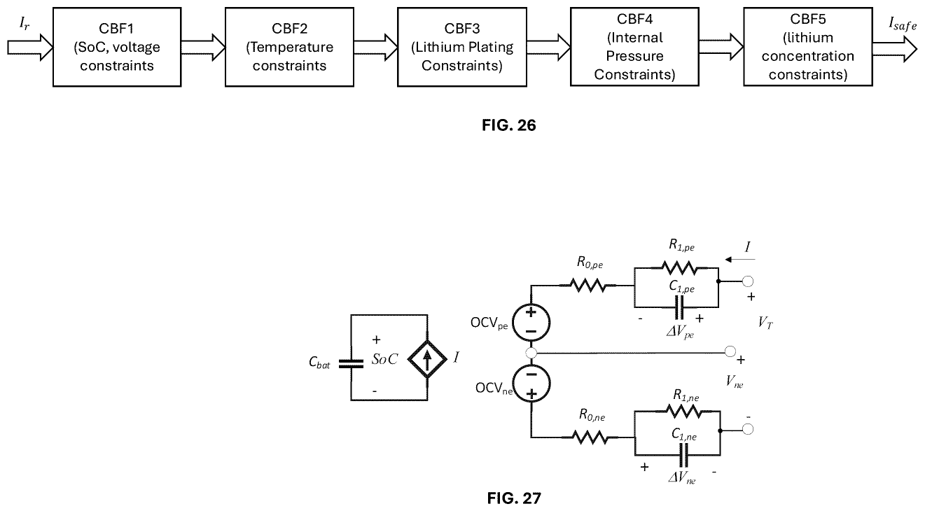

Additional safety constraints may be incorporated into the disclosed battery safety framework as additional cascade CBF. In addition to the two CBFs described above, CBF1: SoC and voltage and CBF2: temperature, the additional constraints include CBF3: limits on lithium plating, CBF4: limits on internal pressure of the battery (to prevent venting of flammable electrolyte), CBF5: limits on lithium concentration CBF6: limits of battery degradation based on semi-empirical aging models. With reference to FIG. 26, these new constraints can be added to existing cascade CBF to provide additional safety benefits.

### CBF3: Limiting Lithium Plating

Lithium platting occurs when lithium-ion deposition on the anode exceeds the rate at which lithium can intercalate into the anode's structure (usually graphite in Lithium-ion batteries), which may occur due to high charging rates and/or low temperatures. This section describes how to prevent lithium plating within the cascade CBF framework. With reference to FIG. 27, to model the lithium platting phenomenon, an equivalent circuit model (ECM) composed of a series of two sub-circuits may be used: one for the battery's cathode, and another for the battery's anode. Each sub-circuit is composed of dependent voltage source that is connected with a resistor and one (or more) resistor-capacitors pair. This allows for mathematically representing the behavior of the circuit in formula (24):

$${\dot{x}}_{LP} = {f}_{LP} ( {x}_{LP} , T ) + {g}_{LP} ( {x}_{LP} , T ) u \qquad ( 24 )$$

where x_{LP}=[SoC,ΔVₚₑ, ΔVₚₑ]^{T} capture states of the ECM, such as capacitor voltages and state of charge; f_{LP}, g_{LP} are functions that can be evaluated using circuit laws (Kirchhoff s current law, voltage law, etc) of formulas (25) and (26):

$${f}_{LP} ( {x}_{LP} , T ) = {[ 0 , - \frac{1}{{C}_{1 , pe} {R}_{1 , pe}} , - \frac{1}{{C}_{1 , ne} {R}_{1 , ne}} ]}^{T} \qquad ( 25 )$$

$${g}_{LP} ( {x}_{LP} , T ) = {[ - \frac{1}{{c}_{bat}} , \frac{1}{{c}_{1 , pe}} , \frac{1}{{c}_{1 , ne}} ]}^{T} \qquad ( 26 )$$

where C_{1,pe}R_{1,pe}, C_{1,ne}R_{1,ne},C_{bat} are parameters of the battery model that can be further dependent on the temperature and SoC and u∈U is the charging current and U the limits of the charger; and T is the battery temperature.

The circuit of FIG. 27 enables prediction of the electrode voltages based on the value of the states x_{LP}. Of particular interest is the voltage in the negative (anode) electrode Vₙₑ(X_{LP}(t)). To prevent lithium platting, the voltage of this electrode needs to be positive. This can be enforced via the inequality of formula (27):

$${V}_{ne} ( {x}_{LP} ( t ) ) \geq {V}_{ne}^{min} \qquad ( 27 )$$

where

$${V}_{anode}^{min}$$

is a positive constant defined by the designer. Formula (27) can be re-written as formula (28)

$${c}_{LP} ( t ) = {V}_{ne} ( {x}_{LP} ( t ) ) - {V}_{ne}^{min} \geq 0 \qquad ( 28 )$$

Formula (28) can be enforced using a zeroing CBF expressed as formula (29)

$${\dot{c}}_{LP} ( {x}_{LP} , u ) = \frac{\partial c}{\partial x} ( {f}_{Lp} ( {x}_{Lp} , T ) + {g}_{Lp} ( {x}_{Lp} , T ) u ) \geq α ( {c}_{LP} ( t ) ) \qquad ( 29 )$$

where α(·) is an extended class K function. The set of charging currents that prevent violation of the lithium plating constraints may be given as formula (30):

$${U}_{LP} ( {x}_{LP} ) = u ∈ U : \frac{\partial {c}_{LP}}{\partial x} ( {f}_{LP} ( {x}_{LP} , T ) + {g}_{LP} ( {x}_{LP} , T ) u ) \geq α ( {c}_{LP} ( t ) ) \qquad ( 30 )$$

To enforce this constraint in the CBF function framework, the following low-dimensional optimization problem can be formulated and expressed as formulas (31a-c):

$${u}_{out} ( x ) = arg min {‖ {u}_{out} - {u}_{in} ‖}^{2} \qquad ( 31 a )$$

$$s . t . {u}_{out} ∈ {U}_{LP} ( {x}_{LP} ) \qquad ( 31 b )$$

$${u}_{out} \leq {u}_{in} \qquad ( 31 c )$$

where uᵢₙ is the charging current computed by the previous CBF (e.g. for temperature or SoC enforcement) and uₒᵤₜ is a safe charging current that prevent lithium plating. This current can be passed to another CBF layer or to the battery charger.

### CBF4: Limiting Internal Pressure of the Battery

This section explains how to limit the internal pressure of the battery during fast charging/discharging of the battery within the cascade CBF safety framework. Enforcement of this safety limit is used to prevent venting of flammable electrolyte during extreme battery operations. The internal pressure is affected by the i) saturation pressure of the electrolyte (Pₛₐₜ) and ii) the pressure generated by the decomposition of the solid-electrolyte interphase (SEI), which is denoted as P_{CO2} in formula (32):

$${P}_{tot} = {P}_{sat} + {P}_{CO 2} \qquad ( 32 )$$

The mathematical model of the first term is defined in formula (33):

$${P}_{sat} ( {T}_{c} ) = {\sum }_{j ∈ J} {D}_{j} {10}^{{A}_{j} \frac{{B}_{j}}{{T}_{c} - {C}_{j}}} \qquad ( 33 )$$

where T_{c} is the core temperature of the battery, J is the set of key components of electrolyte (e.g. ethylene carbonate, dimethyl carbonate, etc.) and Aⱼ, Bⱼ, Cⱼ, Dⱼ are parameters.

The mathematical model of the second term (P_{CO2}) is defined in formula (34):

$${P}_{CO 2} ( {n}_{CO 2} , {T}_{c} ) = \frac{{n}_{CO 2} {RT}_{C}}{{V}_{h}} \qquad ( 34 )$$

where n_{CO2} is amount of CO2, R the ideal gas constant, and Vₕ the headspace volume along the edges of the battery cell. The amount of CO₂ is dependent on the SEI decomposition, which is captured using an Arrhenius-like reaction model of formulas (35a-b):

$$\frac{d}{dt} {x}_{SEI} = - {θ}_{1} {x}_{SEI} exp ( - \frac{{θ}_{2}}{{T}_{C}} ) \qquad ( 35 a )$$

$${n}_{CO 2} = {θ}_{3} - {θ}_{4} {x}_{SEI} \qquad ( 35 b )$$

where θ₁, . . . , θ₄ are the parameters of the model, assumed to be known. The total internal pressure can be defined in formula (36):

$${P}_{tot} ( {T}_{c} , {x}_{SEI} ) = {h}_{p} ( {T}_{c} , {x}_{SEI} ) = {\sum }_{j ∈ J} {D}_{j} {10}^{{A}_{j} \frac{{B}_{j}}{{T}_{{C}^{-}} {C}_{j}}} + \frac{( {θ}_{3} - {θ}_{4} {x}_{SEI} ) {RT}_{C}}{{V}_{h}} \qquad ( 36 )$$

Since the pressure depends on the battery temperature, a model to predict battery temperature is provided. Considering the following formula

$${x}_{th} = {[ {T}_{c} , {T}_{s} ]}^{T}$$

expressing the core and surface temperature. The dynamics of these temperature are provided in formula (37)

$$\dot{{x}_{th}} \approx {f}_{2} ( {x}_{th} ) + {g}_{2} ( {x}_{th} ) {u}^{2} \qquad ( 37 )$$

where f₂, g₂ are functions previously introduced in this document and u the battery current.

Considering

$$z = {[ {x}_{SEI} , {x}_{th}^{T} ]}^{T} ,$$

which contains the SEI and temperature state, the following formulas are derived (38a-b)

$$\dot{z} = {f}_{z} ( z ) + {g}_{z} ( z ) {u}^{2} \qquad ( 38 a )$$

$${P}_{tot} = {h}_{p} ( z ) \qquad ( 38 b )$$

Where

$${f}_{z} ( z ) = {[ - {θ}_{1} {x}_{SEI} exp ( - \frac{{θ}_{2}}{{T}_{C}} ) , {{f}_{2} ( z )}^{T} ]}^{T}$$

and g_{z}(z)=[0,g₂(z)]^{T}. A maximum pressure to prevent venting of flammable electrolyte may be specified based on formula (39):

$${P}_{tot} = {h}_{p} ( z ) \leq {p}_{m ax} \qquad ( 39 )$$

where pₘₐₓ is the maximum pressure. This constraint can be re-written as formula (40):

$${c}_{pre} ( z ) = - {h}_{p} ( z ) + {p}_{m ax} \geq 0 \qquad ( 40 )$$

The set of safe states is defined as X_{safe}={xₚᵣₑ:cₚᵣₑ(xₚᵣₑ)>0}. It can be enforced using a zeroing CBF of formula (41):

$${\dot{c}}_{pre} ( z , u ) = \frac{\partial {c}_{pre}}{\partial z} ( {f}_{z} ( z ) + {g}_{z} ( z ) {u}^{2} ) \geq {α}_{pre} ( {c}_{pre} ( t ) ) \qquad ( 41 )$$

where αₚᵣₑ(·) is an extended class K function defined by the user. The set of charging currents that prevent violation of pressure constraints is defined as formula (42):

$${U}_{pre} ( z ) = \{ u ∈ U : \frac{\partial {c}_{pre}}{\partial z} ( {f}_{z} ( z ) + {g}_{z} ( z ) {u}^{2} ) \geq {α}_{pre} ( {c}_{pre} ( z ) ) \} \qquad ( 42 )$$

To enforce this constraint in cascade CBF function framework, it can be formulate using the following low-dimensional optimization problem expressed as formulas (43a-c):

$${u}_{out} ( z ) = arg min {‖ {u}_{out} - {u}_{i n} ‖}^{2} \qquad ( 43 a )$$

$$s . t . {u}_{out} ∈ {U}_{pre} ( z ) \qquad ( 43 b )$$

$${u}_{out} \leq {u}_{i n} \qquad ( 43 c )$$

where uᵢₙ is the charging current computed by the previous CBF (e.g. for temperature or SoC enforcement) and uₒᵤₜ is a safe charging current that prevent overpressure. This current can be passed to another CBF or to the battery charger.

### CBF5 Limits on Chemical Concentration of Lithium

This section explains how to enforce safety constraints using physics-based ECMs. These ECMs rely on circuit elements (resistors, capacitors, voltage/current sources) to represent the several electro-chemical processes of lithium-ion batteries, including, for example, charge transfer, mass transport of lithium ions in the solid particles and mass transport of lithium ions in the liquid electrolyte.

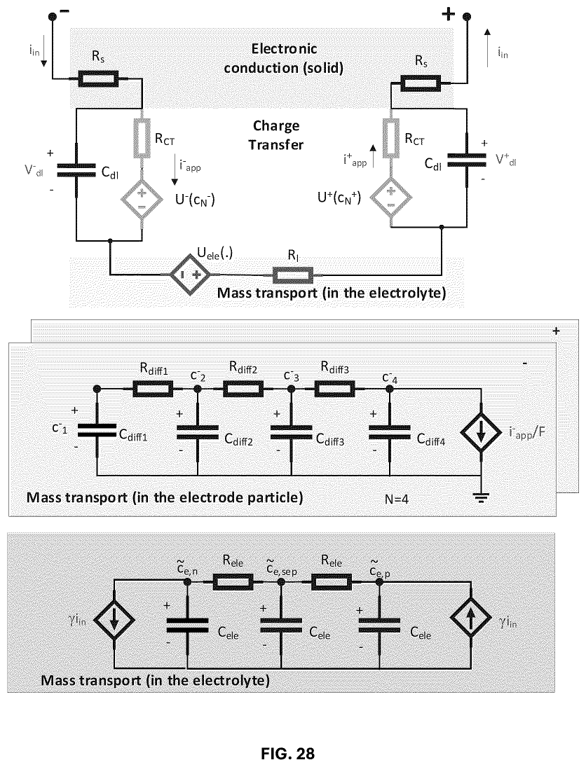

FIG. 28 provides a representation of a physics-based ECM and includes the following components:
The resistor Rₛ captures the electronic resistance when the electrons move in the solid phase of the electrode;
The resistor R_{ct} captures the charge transfer and can be approximated using a linear approximation of the Butler-Volmer equation;
The RC pairs R_{diff,n}C_{diff,n} emulate the mass transport of lithium in the solid phase. The voltage in the capacitors

$${c}_{n}^{-}$$

represent the concentration of lithium in the solid phase inside a negative electrode particle, while

$${c}_{n}^{+}$$

is the concentration of lithium inside a positive electrode particle (note: n∈{1, . . . , N});
The voltage source

$${U}^{-} ( {c}_{N}^{-} )$$

represents the (negative) electrode potential, which varies with the surface concentration of lithium in the particle;
C_{d1} captures the double layer capacitance; and
The resistors R₁ captures the overpotential caused by lithium transport in the electrolyte Rₑ; and
The RC pairs Rₑₗₑ,Cₑₗₑ emulate the mass transport of lithium in the electrolyte; the capacitor voltages cₑ=[\tilde{c}_{e,n}, \tilde{c}_{e,sep},\tilde{c}_{e,pos}]^{T} approximate the concentration of lithium ions in the negative electrode, separator and positive electrode; the voltage source Uₑₗₑ(Cₑ) represents the electrolyte potential.

The voltages across the capacitors represent the states of the ECM and are given by formula (44):

$${C}_{dl} \frac{d {V}_{dl}^{-}}{dt} = {i}_{app}^{-} + {i}_{i n} \\ {C}_{diff , 1} \frac{{dc}_{1}^{-}}{dt} = \frac{{C}_{2}^{-} - {C}_{1}^{-}}{{R}_{diff , 1}} \\ {C}_{diff , n} \frac{{dc}_{n}^{-}}{dt} = \frac{{c}_{n + 1}^{-} - {c}_{n}^{-}}{{R}_{diff , n}} - \frac{{c}_{n}^{-} - {c}_{n - 1}^{-}}{{R}_{diff , n - 1}} , n = 2 , … , N - 1 \\ {C}_{diff , N} \frac{{dc}_{N}^{-}}{dt} - {i}_{app}^{-} - \frac{{C}_{N}^{-} - {C}_{N - 1}^{-}}{{R}_{diff , N - 1}} \\ {C}_{ele} \frac{d}{dt} {\tilde{c}}_{e , p} = \frac{{\tilde{c}}_{e , sep} - {\tilde{c}}_{e , p}}{{R}_{ele}} + γ {i}_{i n} \\ {C}_{ele} \frac{d}{dt} {\tilde{c}}_{e , sep} = \frac{{\tilde{c}}_{e , p} - {\tilde{c}}_{e , sep}}{{R}_{ele}} - \frac{{\tilde{c}}_{e , sep} - {\tilde{c}}_{e , n}}{{R}_{ele}} \\ {C}_{ele} \frac{d}{dt} {\tilde{c}}_{e , n} = \frac{{\tilde{c}}_{e , sep} - {\tilde{c}}_{e , n}}{{R}_{ele}} - γ {i}_{i n} \qquad ( 44 )$$

The differential equations for the positive electrode

$$( {c}_{n}^{+} , {V}_{dl}^{+} )$$

have a similar structure and are omitted for the sake of brevity. Kirchhoff's voltage law can be used to compute

$${i}_{app}^{-}$$

using formulas (45a-b)

$${V}_{dl}^{-} = {R}_{ct} {i}_{app}^{-} + {U}^{-} ( {c}_{N}^{-} ) \qquad ( 45 a )$$

$${i}_{app}^{-} = \frac{{V}_{dl}^{-} - {U}^{-} ( {c}_{N}^{-} )}{{R}_{ct}} = g ( {V}_{dl}^{-} , {c}_{N}^{-} ) \qquad ( 45 b )$$

The augmented state can be expressed as follows

$$x = {[ {V}_{dl}^{-} , {c}_{1}^{-} , {c}_{2}^{-} , … , {c}_{N}^{-} , {\tilde{c}}_{e , n} , {\tilde{c}}_{e , sep} , {\tilde{c}}_{e , pos} , {c}_{1}^{+} , {c}_{2}^{+} , … , {c}_{N}^{+} , {V}_{dl}^{+} ]}^{T} ,$$

which contains the voltages in the double-layer capacitors, the lithium concentrations in the (negative and positive) electrode particles and the concentration of lithium ions in the electrolyte. The dynamic evolution of x can be predicted using the model of formula (46)

$$\frac{d}{dt} x = Ax + {A}_{g} g ( x ) + Bu \qquad ( 46 )$$

where (A, A_{g}, B) are matrices determined based on (E1) and u=iᵢₙ is the battery current.

It might be desirable to enforce a limit in the concentration of lithium in the negative electrode

$$( {c}_{N}^{-} )$$

using formula (47):

$${c}_{N}^{-} \geq {c}_{min} \qquad ( 47 )$$

where cₘᵢₙ is a user defined limit. This can be re-written as formula (48):

$$c ( t ) = {c}_{N}^{-} - {c}_{min} \geq 0 \qquad ( 48 )$$

And enforced using a zeroing CBF of formula (49):

$$\dot{c} ( x , u ) = \frac{\partial c}{\partial x} ( Ax + {A}_{g} g ( x ) + Bu ) \geq α ( c ( t ) ) \qquad ( 49 )$$

where α(·) is an extended class K function. The set of charging currents that prevent violation of the limits in the concentration of lithium are expressed as formula (50):

$${U}_{lc} ( x ) = \{ u ∈ U : \frac{\partial c}{\partial x} ( Ax + {A}_{g} g ( x ) + Bu ) \geq α ( c ( t ) ) \} \qquad ( 50 )$$

To enforce this constraint in the cascade CBF function framework, the following low-dimensional optimization problem can formulated as formulas (51a-c):

$${u}_{out} ( x ) = arg min {‖ {u}_{out} - {u}_{in} ‖}^{2} \qquad ( 51 a )$$

$$s . t . {u}_{out} ∈ {U}_{lc} ( x ) \qquad ( 51 b )$$

$${u}_{out} \leq {u}_{in} \qquad ( 51 c )$$

where uᵢₙ is the charging current computed by the previous CBF (e.g. for temperature or SoC enforcement) and uₒᵤₜ dis a safe charging current that prevent violation of lithium concentration limits. This current can be passed to another CBF layer or to the battery charger. The above example focused on limiting the concentration at the surface of the negative electrode

$${c}_{N}^{-} .$$

The same approach can be used to enforce limits of lithium in the positive electrode

$$( {c}_{+}^{-} )$$

and electrolyte (\tilde{c}_{e,n}, \tilde{c}_{e,sep},\tilde{c}_{e,pos}).
CBF6 Limit Battery Aging with Semi-Empirical Model

This section explains how to integrate generic battery aging constraints within the cascade CBF safety framework. Battery degrades over time and as a result of charging/discharge cycling. This leads to loss of ability to deliver power and energy (also known as capacity loss). As an example, loss of capacity [Ah] due to cycling is also considered. It is assumed that the capacity loss can be mapped by the following function of formula (52):

Cₗₒₛₛ=fₗₒₛₛ(T,θₗₒₛₛ,u) (in % capacity loss/discharge cycle) (52)
where fₗₒₛₛ is a known function that depends on the battery temperature (T), current (u) and parameters (θ). Assuming that the end user of the battery specifies a maximum capacity loss during the charging/discharging process of the battery it can be expressed as formula (53):

$${C}_{loss} = {f}_{loss} ( T , {θ}_{loss} , u ) \leq {C}_{loss , max} \qquad ( 53 )$$

The set of current that fulfills this limit is defined as formula (54):

$${U}_{loss} ( T ) = \{ u ∈ U : {f}_{loss} ( T , {θ}_{loss} , u ) \leq {C}_{loss , max} \} \qquad ( 54 )$$

To enforce this constraint in the cascade CBF function framework, it can be formulated as the following low-dimensional optimization problem in formulas (55a-c):

$${u}_{out} ( {x}_{LP} , T , q ) = arg min ‖ {u}_{out} - {u}_{in} {‖}^{2} \qquad ( 55 a )$$

$$s . t . {u}_{out} ∈ {U}_{loss} ( T ) \qquad ( 55 b )$$

$${u}_{out} \leq {u}_{in} \qquad ( 55 c )$$

where uᵢₙ is the charging current computed by the previous CBF and uₒᵤₜ is a charging current that limits battery aging using a semi-empirical model. This current can be passed to another CBF or to the battery charger.

The following Examples illustrate embodiments of the present disclosure. These Examples are intended to be illustrative only and are not intended to limit the scope of the present disclosure. Also, parts and percentages are by weight unless otherwise indicated.

### EXAMPLES

### Example 1

This example describes simulation of the cascade CBF based algorithms according to the present disclosure using computer simulations.

The battery is modeled using an electro-thermal model of FIG. 1 and parameterized with data from a 2.3 Ah A123 26650 LiFePO₄ battery cell. The simplified electro-thermal battery model used in the cascade CBF formulation incorporates three states and associated constraints. In this model, the electrical behavior of the battery is represented by a single RC pair, including resistance R1 and capacitance C1, to capture the essential voltage dynamics. For thermal characteristics, a lumped thermal model is used, involving a cell heat capacity Cth and a heat convection resistance Rth, which collectively approximate the heat transfer and thermal response of the cell. To simplify the CBF implementation, the electro-thermal model used in the CBF i) assumes perfect knowledge of battery states (e.g., via sensors) and ii) adopts an electro-thermal model with constant parameters, valid at SoC of 50%. The parameters applied in the CBF model are listed in Table 4 of FIG. 12. The two Quadratic Programming (QP) optimization problems of the cascade CBF (P₁ and P₂), are solved using the quadprog function from MATLAB's Optimization Toolbox.

Fast charging was evaluated by comparing cascade CBF algorithm vs CC-CV charging. The first test focuses on fast charging of the battery cell with the following safety limits: Vt=3.6V, SOC=1, Ts=29.5° C., I=23A(10 C). The two charging algorithms considered were: 1) cascade CBF algorithm according to the present disclosure, parameterized with α1(c2)=0.05c2, Kα=[0.05,0.6] and desired current Ir=I; and CC-CV, with a constant current of 6.9 A (3 C), which allows the battery to reach the maximum Ts at the end of charging, and a constant voltage of 3.6 V—the terminal voltage recommended by the battery manufacturer.

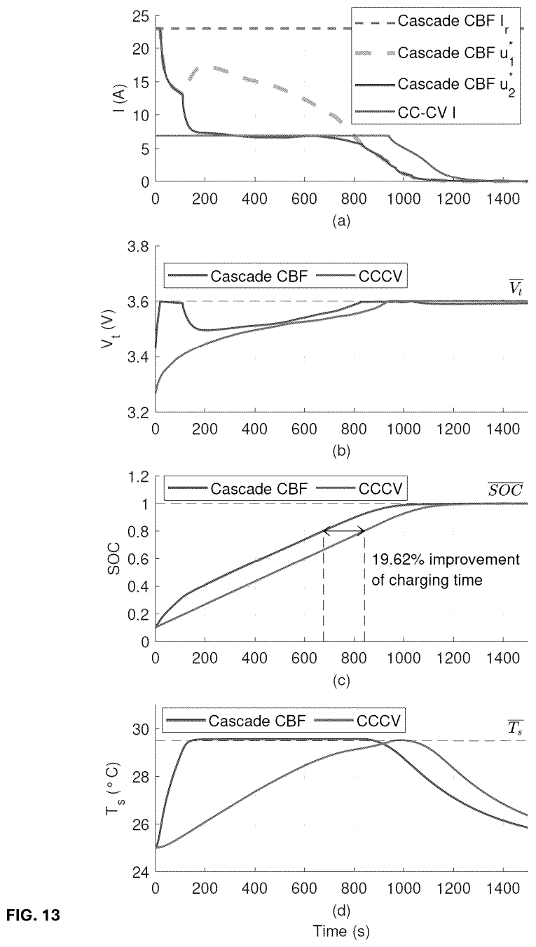

FIG. 13 shows obtained simulation results of fast battery charging with cascade CBF and CC-CV. The results include (a) charging current, (b) terminal voltage, (c) SoC and (d) surface temperature plots, which show that the cascade CBF operates most of the time at the limit of one of the safety constraints. For the current limit, during the first 40 s, the charging current of the cascade CBF matches the reference Ir. For the voltage limit, from t∈[40,100]s, the charging current decreases quickly to prevent violation of the battery's maximum voltage. For the temperature limit at t≈100 s, the surface temperature Ts reaches its maximum limit, activating the second CBF constraint, which reduces the charging current to 7 A to prevent violation of Ts. For the voltage limit at t≈900 s, the SoC constraint becomes dominant, and the charging current is gradually reduced to zero, concluding the charging process.

These results suggest that the cascade CBF implements a CC-CV-CT-CV2 charging protocol. Plots of FIG. 13 also show the results of the CC-CV baseline charging algorithm. This baseline method reaches the same maximum battery temperature (Ts) as the cascade CBF but increases the charging time by 19.62%. The reduction in charging time offered by the cascade CBF is achieved mostly during the initial phase, where a large charging current is applied before the battery reaches its thermal limit. After reaching the thermal limit, both charging algorithms exhibit a similar pattern.

Performance of cascade CBF was also compared against i) the central CBF and ii) an MPC algorithm. The nonlinear solver Ipopt was used to implement the central-CBF-based optimization controller P0 and the MPC-based controller. The simulations were conducted with a 0.10.1-second fixed step size and ran for 1500 seconds.

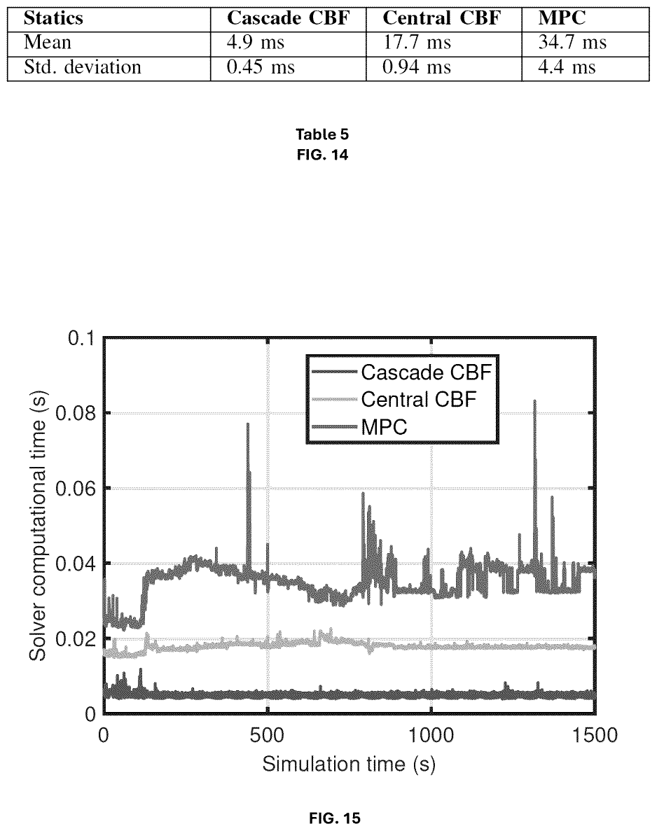

The time-domain response of the three algorithms is very similar to the results depicted in FIG. 13 and is therefore omitted here for brevity. Table 5 of FIG. 14 and plot of FIG. 15 provide a summary of the computational times required to execute each of the fast-charging algorithms. In this context, computational time refers to the elapsed time needed to solve the optimization problem to a satisfactory tolerance level. These times were measured on a desktop computer with an Intel® Core™ i3-10100 CPU @3.60 GHz and 16 GB of memory. On average, the cascade CBF is 7 times faster than the MPC and about 3.6× faster than the central CBF. The standard deviation of computational time also indicates that MPC has greater variability in computational costs when compared to CBF. This comparison demonstrates that our approach can achieve the same safety guarantees as MPC but with significantly reduced computational costs, making it more suitable for implementation in real-world embedded applications with limited computational resources.

The second use case focuses on validating the state of power of the battery. This test assumes that the power requested from the battery, pbat*, follows a 1:31:3 scaled-down European Artemis Rural driving cycle. During the simulation, the battery is subjected to the following constraints: Vt=3.4V, Vt=3.0V, SOC=0.4, Ts=27° C., I=25 A, I=−25 A

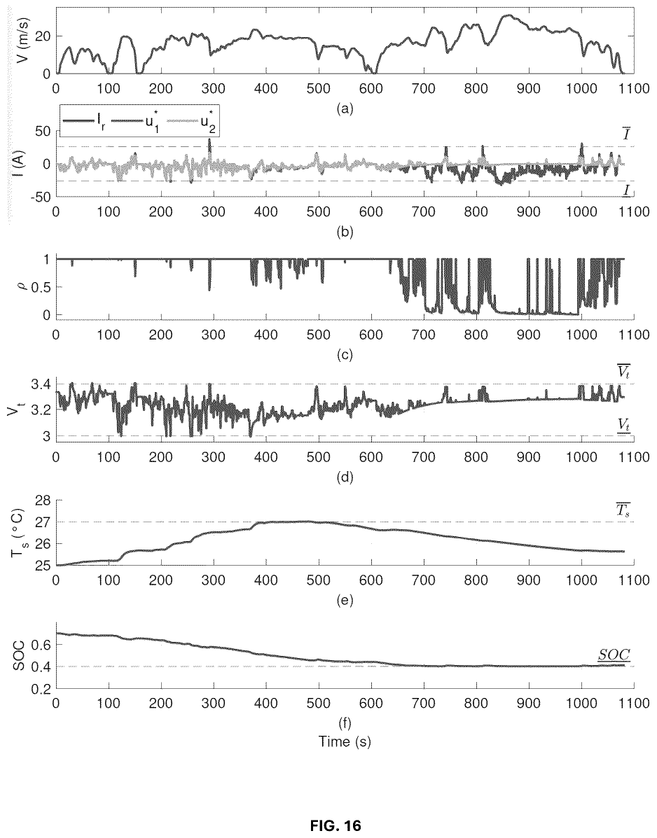

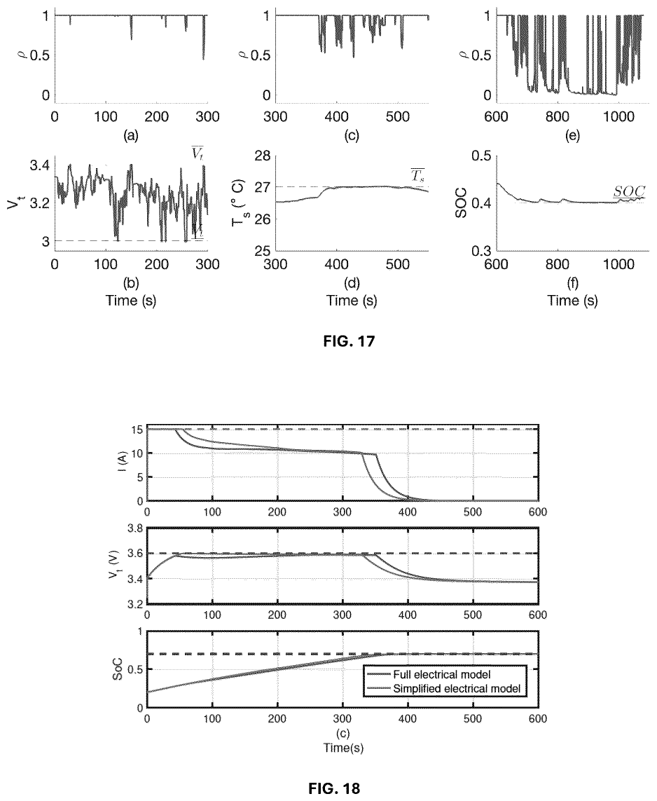

FIGS. 16 and 17 show the obtained simulation results. During the first 300 seconds the current/power requested by the emulated vehicle powertrain is mostly fulfilled. Only small-time windows exist where the maximum (i.e., regenerative) current is reduced to prevent violation of the upper terminal voltage constraint (see FIG. 17 plots (a) and (b)). Practically, this would imply a reduction in the regenerative braking available to the vehicle at the beginning of the drive, when the battery is nearly fully charged, and the upper voltage constraint is at higher risk of being violated.

From 400 to 500 seconds the battery is mainly thermally constrained. The state of power is systematically reduced by up to 50% to avoid breaching the upper battery temperature limit. FIG. 17 plots (c) and (d) provide a detailed time zoom of this operating mode.

After 600 seconds the battery approaches the lower SoC limit. The cascade CBF significantly decreases the power level requested from the battery to avoid violation of SoC constraints (see FIG. 17 plots (e) and (f)).

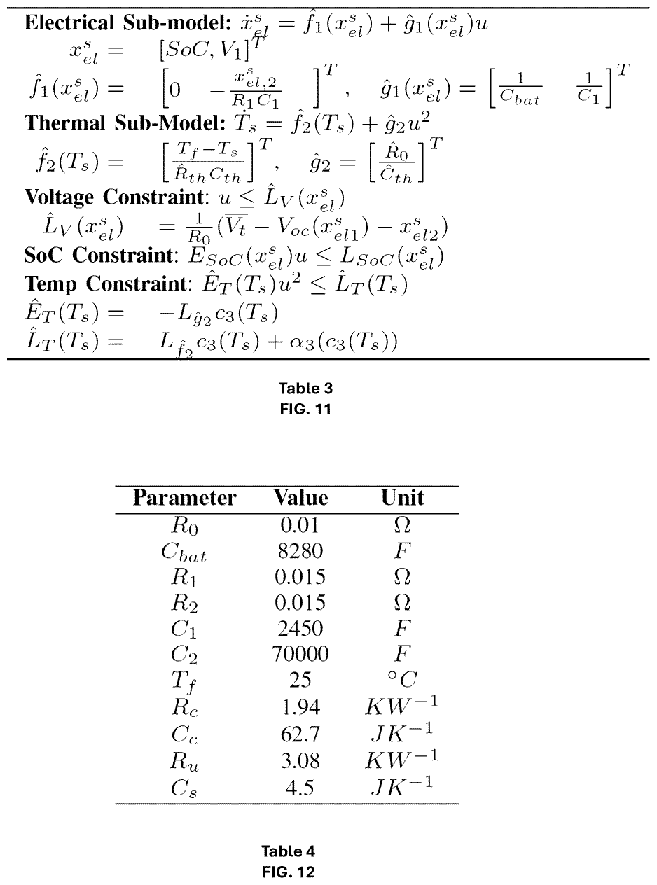

Using a simplified model in the design of the cascade CBF was also investigated to i) approximate the electrical equivalent model of the battery with a single RC pair (instead of two as presented) and ii) use surface temperature as the single state (instead of both core and surface temperatures as presented with respect to FIG. 1). As shown in Table 3 of FIG. 11, this simplified model has a configuration similar to the one introduced in FIG. 1. However, there are two differences. First, the number of states is reduced from 5 to 3, decreasing complexity. Second, the temperature constraint has a relative degree of 1, allowing to formulate the temperature CBF constraint as shown in formula (56), where α3(·) is an extended class K user-defined function in formula (56):

$$c \cdot 3 ( x , u ) \geq - α 3 ( c 3 ( x ) ) \qquad ( 56 )$$

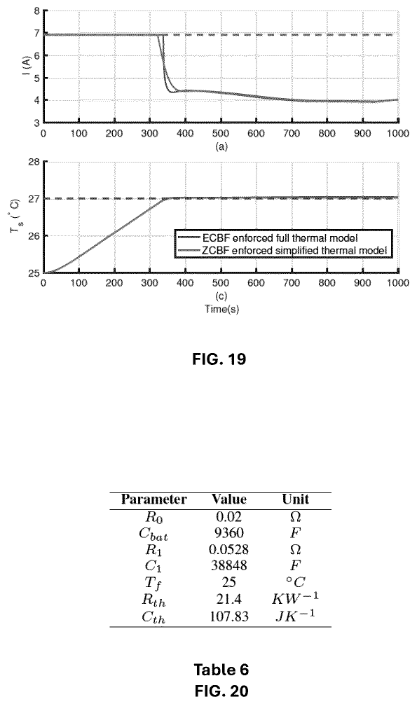

FIGS. 18 and 19 compare the performance of the cascade CBF designed with both full-order and simplified battery models. The battery temperature response is nearly identical for both the reduced and full models, showing very similar charging currents (FIG. 19). The electrical response of the cascade CBF with a single RC pair also demonstrates comparable terminal voltage and SoC to the CBF configured with two RC pairs.

This simulation analysis indicates that the CBFs designed with the simplified battery model effectively ensure electrical and thermal safety while reducing model complexity. Since these CBFs are easier to implement (e.g., they do not require core temperature estimation), these simplified formulations were chosen for the experimental validation of the cascade CBF, as presented in Example 2.

### Example 2

This example describes experimental validation of the cascade CBF based algorithms according to the present disclosure.

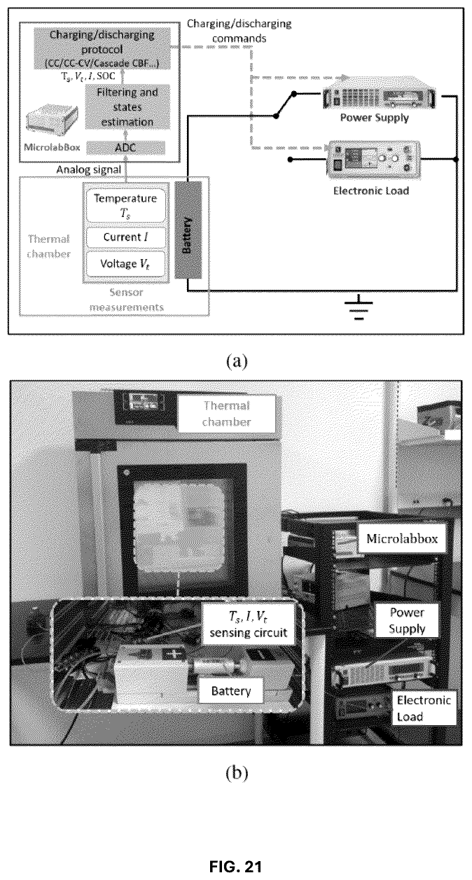

FIG. 21 shows a schematic diagram (a) and actual implementation (b) of the test platform employed in the experimental validation of the cascade CBF. This platform included:
A single battery cell (26650 LiFePO4);
A controllable power supply (EA-PS 9080-60) that regulates the charging current or power applied to the battery;
A programmable electronic load (EA-EL 9080-45) that requests discharge current from the battery based on a scaled-down driving cycle for measuring battery temperature, a Hall effect current transducer (CAS 25-NP), and an isolated voltage sensor (8B51);
A dSPACE MicroLabBox, which is used for signal processing, state estimation, and execution of the charging algorithms. The MicroLabBox sends current setpoints to the power supply or electronic load using a SCPI (Standard Commands for Programmable Instruments) protocol and receives the battery sensing data through analog-to-digital converters; and
A thermal chamber (Memmert UN110), which is used to maintain constant ambient temperature during the test.

Before implementing the cascade CBF, the parameters of the battery model were calibrated. This calibration was performed based on a series of identification tests. The open-circuit voltage, Voc, was calibrated using data from a low-current discharge (C/20). The series resistance R0 and RC pair (R1, C1) of the electrical-equivalent circuit model were estimated using a pulse current excitation and least-squares fitting techniques. Least squares were also employed to fit the thermal model using test data from a 5 A constant current discharge test. Table 6 of FIG. 20 summarizes the identified battery parameters.

The implementation of the cascade CBF also requires access to states that are not directly measured, such as SoC and V1. To estimate these states, an Extended Kalman Filter (EKF) was employed. In addition to state estimation, this EKF also estimates variations in the parameters R0 and Cbat, which are treated as extended states perturbed by random Gaussian noise.

The first experimental test focuses on the fast charging of the test cell with the following safety limits Vt=3.55V, SOC=0.7, Ts=32° C., I=15 A. Two charging controllers were evaluated: i) a cascade CBF (composed of P1 and P2) with a constant reference (Ir=I) and ii) a 6 A-3.55V CC-CV. The extended class K functions of the two CBFs are parameterized as:

$$α 1 ( c 2 ) = 0.05 c 2 , α 3 ( c 3 ) = 0.0005 c 3 + 0.002 {c}_{3}^{3} .$$

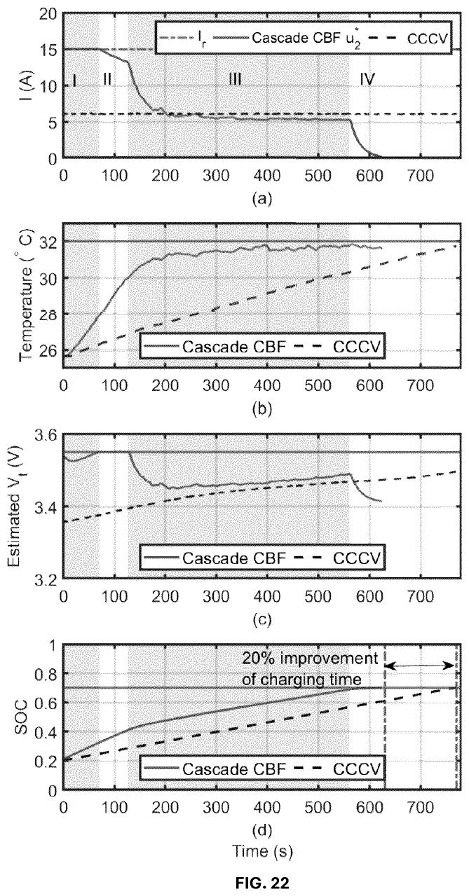

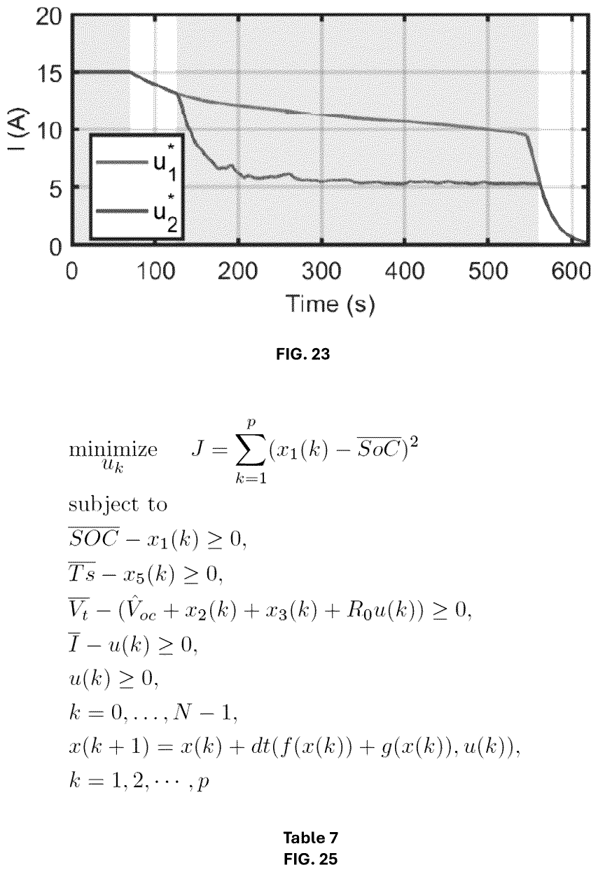

FIG. 22 illustrates the time evolution of the charging current of the cascade CBF. This evolution can be divided into four main stages:
Stage I: The cascade CBF charges the battery with a maximum constant current, Ir=15 A;
Stage II: As the estimated terminal voltage increases, the voltage constraint becomes active, and the charging current u1* slightly decreases, as shown in a plot of FIG. 23;
Stage III: As charging continues, the battery temperature rises, triggering the activation of the temperature constraint and causing a reduction in the charging current u2*, which stabilizes at approximately 6 A (see FIG. 23); and
Stage IV: The SoC constraint becomes active, further reducing the charging current to 0 A, concluding the charging protocol.

FIG. 23 provides additional details on the current limits set by the first (u1*) and second (u2*) CBF controllers. It is noteworthy that the first loop, which is responsible for voltage and SoC constraints, dictates the charging current in Stages I, II, and IV, while the second loop (temperature constraint) limits the charging current in Stage III.

Returning to plot (d) of FIG. 13, the cascade CBF reduced the charging time by 20% when compared to the CC-CV charging. This improvement closely aligns with the predictions from numerical simulations, demonstrating the practical applicability of the cascade CBF.

The second test focuses on the experimental validation of the cascade CBF during a discharge scenario. This test employs a scaled-down power version ( 1/10 factor) of the driving cycle Vires Rural Road Descent 1 Track, calculated based on the powertrain of the Robomobil EV. Due to limitations in the experimental setup of FIG. 21, regenerative braking was disabled during this test. The following safety limits were considered: Vt=3V, SOC=0.4, Ts=28° C., I=15 A.

FIG. 24 shows the results of this discharge scenario. During the initial phase (t∈[0,150]s), the battery can meet the current/power demands of the powertrain. As discharging progresses, the battery temperature increases, activating the temperature constraint, which limits the current/power drawn from the battery. The CBF generates a “peak shaving” derating strategy, reducing the maximum current/power during periods of strong acceleration. This experimental test demonstrates that the cascade CBF effectively derates battery performance to adhere to safety constraints.

This disclosure presents a battery safety algorithm based on CBFs. This algorithm is designed to ensure the satisfaction of electro-thermal safety constraints during battery charging and discharging processes. The present CBF approach is structured in a cascading manner, with the first CBF loop focusing on temperature safety and the second CBF loop handling the SoC and voltage constraints. Simulations confirm that this cascade CBF framework effectively preserves battery safety while significantly reducing computational costs compared to other optimization-based controllers, such as MPC.

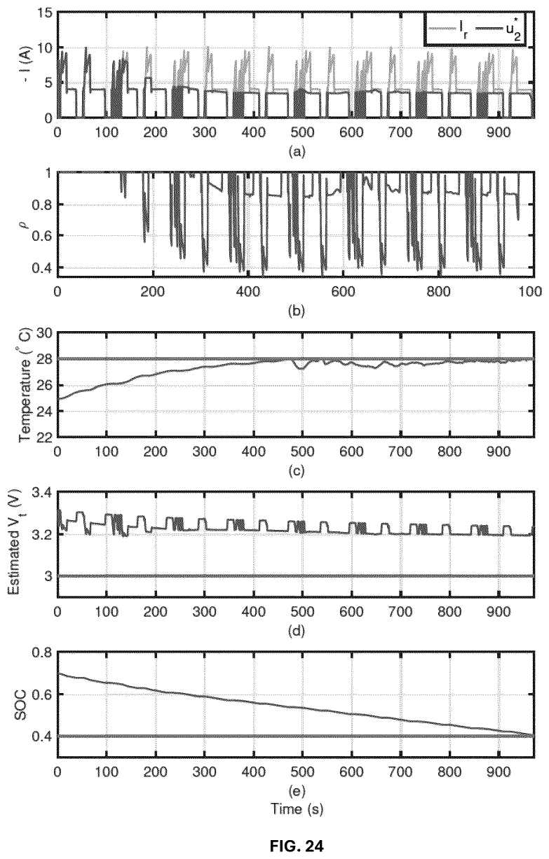

To demonstrate the computational efficiency of the present Cascade-CBF controller, the computational time of the Cascade-CBF controller is compared with that of an MPC-based controller with the same control objectives. To find the optimal control action, the present MPC formulates and solves the following optimization problem listed in Table 7 of FIG. 25, where x=[SOC, V1, V2, Tc, Ts]T represents the battery states. The problem optimizes the control action u over a prediction horizon p with a discrete time step dt, aiming to minimize the cost function J, which computes the total deviation of SoC from the target SoC across the prediction horizon. The first three constraints in the MPC problem correspond to the safety limits on maximum SoC, surface temperature, and terminal voltage. The fourth and fifth constraints ensure that the charging current u remains within 0≤u≤I throughout the prediction horizon. The last equality constraint defines the prediction model of the battery dynamics. The MPC controller was configured with a prediction horizon p=20 and a time step dt=0.1 seconds.

Alternate embodiments may be devised without departing from the spirit or the scope of the present technology. Additionally, well-known elements of embodiments of the systems, apparatuses, and methods have not been described in detail or have been omitted so as not to obscure the relevant details of the systems, apparatuses, and methods.

The terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

When the terms “coupled” and “connected,” along with their derivatives, are used, these terms are not intended as synonyms for each other. For example, “connected” may be used to indicate that two or more elements are in direct physical or electrical contact with each other. “Coupled” may mean that two or more elements are in direct physical or electrical contact (e.g., directly coupled) or that two or more elements are not in direct contact with each other but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in tum, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Various embodiments of the systems, apparatuses, and methods have been described, and in many of the different embodiments many features are similar. To avoid redundancy, repetitive description of these similar features may not be made in some circumstances. It shall be understood, however, that description of a first-appearing feature applies to the later described similar feature and each respective description, therefore, is to be incorporated therein without such repetition.

From the foregoing, it will be appreciated that specific embodiments of the disclosure have been described herein for purposes of illustration, but that various modifications may be made without deviating from the scope of the disclosure. Accordingly, the disclosure is not limited except as by the appended claims.

What is claimed is:

1. A method for charging a battery, the method comprising:
receiving an initial charging current and at least one battery parameter at a processor;
calculating a first charging current based on the initial charging current using a first control barrier function enforcing state of charge (SoC) and voltage constraints based on the at least one battery parameter;
calculating a safe charging current based on the first charging current using a second control barrier function enforcing a temperature constraint; and
controlling charging of the battery using the safe charging current to maintain SoC, voltage, and temperature within specified limits.

2. The method according to claim 1, further comprising:
adjusting the safe charging current using a third control barrier function enforcing a lithium plating constraint; and
controlling charging of the battery using the safe charging current to prevent lithium deposition on an anode surface and maintain battery safety.

3. The method according to claim 2, further comprising:
adjusting the safe charging current using a fourth control barrier function enforcing an internal pressure constraint; and
controlling charging of the battery using the safe charging current to maintain internal pressure within safe operational limits and prevent electrolyte venting.

4. The method according to claim 3, further comprising:
adjusting the safe charging current using a fifth control barrier function enforcing a lithium concentration constraint; and
controlling charging of the battery using the safe charging current to maintain lithium-ion concentration within operational thresholds and prevent electrolyte depletion or saturation effects.

5. The method according to claim 4, further comprising:
adjusting the safe charging current using a sixth control barrier function enforcing a battery aging constraint; and
controlling charging of the battery using the safe charging current to reduce degradation effects and extend battery lifespan.

6. The method according to claim 1, further comprising:
calculating state of power estimation.

7. The method according to claim 6, wherein the state of power estimation includes:
receiving requested battery power at the processor;
calculating requested battery current based on the requested battery power; and
calculate maximum safe battery power using cascade control barrier functions.

8. The method according to claim 7, wherein the requested battery power is associated with regenerative braking in an electric vehicle.

9. The method according to claim 7, wherein the requested battery power is associated with acceleration in an electric vehicle.

10. The method according to claim 1, wherein the at least one battery parameter is one of an electrical safety limit or a thermal safety limit.

11. The method according to claim 1, wherein the first control barrier function is solved by a quadratic optimization that minimizes deviation from a reference charging current, subject to SoC and voltage constraints.

12. The method according to claim 1, wherein the second control barrier function is solved by a quadratic optimization that minimizes deviation from the first charging current, subject to temperature constraints.

13. A battery management system for charging a battery, the system comprising:
a battery;
a charger;
a processor configured to:
receive an initial charging current and at least one battery parameter;
calculate a first charging current based on the initial charging current using a first control barrier function enforcing state of charge (SoC) and voltage constraints based on the at least one battery parameter;
calculate a safe charging current based on the first charging current using a second control barrier function enforcing a temperature constraint; and
control the charger to charge the battery using the safe charging current to maintain SoC, voltage, and temperature within specified limits.

14. The system according to claim 13, wherein the processor is further configured to:
adjust the safe charging current using a third control barrier function enforcing a lithium plating constraint; and
control charging of the battery using the safe charging current to prevent lithium deposition on an anode surface and maintain battery safety.

15. The system according to claim 14, wherein the processor is further configured to:
adjust the safe charging current using a fourth control barrier function enforcing an internal pressure constraint; and
control charging of the battery using the safe charging current to maintain internal pressure within safe operational limits and prevent electrolyte venting.

16. The system according to claim 15, wherein the processor is further configured to:
adjust the safe charging current using a fifth control barrier function enforcing a lithium concentration constraint; and
control charging of the battery using the safe charging current to maintain lithium-ion concentration within operational thresholds and prevent electrolyte depletion or saturation effects.

17. The system according to claim 16, wherein the processor is further configured to:
adjust the safe charging current using a sixth control barrier function enforcing a battery aging constraint; and
control charging of the battery using the safe charging current to reduce degradation effects and extend battery lifespan.

18. The system according to claim 13, wherein the processor is further configured to: calculate a state of power estimation for the battery.

19. The system according to claim 18, wherein the processor is configured to perform the state of power estimation by:
receiving a requested battery power;
calculating a requested battery current based on the requested battery power; and
calculating a maximum safe battery power using cascade control barrier functions.

20. The system according to claim 19, wherein the requested battery power corresponds to regenerative braking in an electric vehicle.

21. The system according to claim 19, wherein the requested battery power corresponds to acceleration in an electric vehicle.

22. The system according to claim 13, wherein the at least one battery parameter includes an electrical safety limit or a thermal safety limit.

23. The system according to claim 13, wherein the processor is configured to solve the first control barrier function by performing a quadratic optimization that minimizes deviation from a reference charging current, subject to SoC and voltage constraints.

24. The system according to claim 13, wherein the processor is configured to solve the second control barrier function by performing a quadratic optimization that minimizes deviation from the first charging current, subject to temperature constraints.
